(19) United States
(12) Patent Application Publication
(10) Pub. No.: US 2025/0291287 A1
(43) Pub. Date: Sep. 18, 2025

(54) HEATING DEVICE, FIXING DEVICE, AND IMAGE FORMING APPARATUS

(71) Applicants: Hiroyuki SHIMADA, Kanagawa (JP); Hitoshi FUJIWARA, Kanagawa (JP); Yuusuke FURUICHI, Kanagawa (JP); Yukimichi SOMEYA, Kanagawa (JP)

(72) Inventors: Hiroyuki SHIMADA, Kanagawa (JP); Hitoshi FUJIWARA, Kanagawa (JP); Yuusuke FURUICHI, Kanagawa (JP); Yukimichi SOMEYA, Kanagawa (JP)

(21) Appl. No.: 19/013,009

(22) Filed: Jan. 8, 2025

(30) Foreign Application Priority Data
Jan. 16, 2024 (JP) 2024-004585

(51) Int. Cl. G03G 15/20

(52) U.S. Cl. CPC G03G 15/2039; G03G 15/2053; G03G 15/2064; G03G 2215/2025

(57) ABSTRACT

A heating device includes an electric wire extending in a first direction, a temperature sensor, an elastic body pressing the temperature sensor in a second direction intersecting the first direction, a first holder holding the temperature sensor, and a second holder holding the first holder. The first holder includes a supported portion extending from one end to another end in a third direction orthogonal to the first direction and the second direction, a supporting portion extending from one end supporting the supported portion to another end in the second direction, a reference face contacting the supporting portion, and a contacting portion contacting the second holder. The supporting portion and the supported portion form a wiring space extending from the supported portion in the second direction and opening toward another end of the supported portion. The second holder has a contact height larger than a height of the wiring space.

### CROSS-REFERENCE TO RELATED APPLICATION

This patent application is based on and claims priority pursuant to 35 U.S.C. § 119(a) to Japanese Patent Application No. 2024-004585, filed on Jan. 16, 2024, in the Japan Patent Office, the entire disclosure of which is hereby incorporated by reference herein.

### BACKGROUND

### Technical Field

The present disclosure relates to a heating device, a fixing device, and an image forming apparatus.

### Related Art

One type of image forming apparatus includes a fixing device. The fixing device is one type of heating device. The fixing device includes a fixing belt that is a rotator, a heater, and a temperature sensor including a temperature detecting element. The temperature detecting element contacts the heater and detects the temperature of the heater to appropriately control the temperature of the fixing belt.

### SUMMARY

The present disclosure described herein provides a heating device including an electric wire, a temperature sensor, an elastic body, a first holder, and a second holder. The electric wire extends in a first direction. The temperature sensor is in contact with a target to detect a temperature of the target. The elastic body presses the temperature sensor toward the target in a second direction intersecting the first direction. The first holder holds the temperature sensor and includes a supported portion, a supporting portion, a reference face, and a contacting portion. The supported portion extends from one end to another end in a third direction orthogonal to the first direction and intersecting the second direction. The supporting portion extends from one end to another end in the second direction. The one end of the supporting portion is connected to the above-described one end of the supported portion. The supported portion is cantilevered from the supporting portion in the third direction to form a wiring space to keep the electric wire extending in the first direction. The reference face contacts said another end of the supporting portion. The contacting portion is raised from the reference face in the second direction. The second holder holds the first holder. The second holder is in contact with the contacting portion of the first holder for a contact height in the second direction. The contact height is larger than a height of the wiring space in the second direction.

The present disclosure described herein also provides a heating device including a rotator, a heater, an electric wire, a temperature sensor, an elastic body, a first holder, and a second holder. The heater includes a base, a heat generator on the base, and a reference face facing the rotator. The electric wire extends in a first direction. The temperature sensor is in contact with a target to detect a temperature of the target. The elastic body presses the temperature sensor toward the target in a second direction intersecting the first direction. The first holder holds the temperature sensor and includes a supported portion, a supporting portion, a reference face, and a contacting portion. The supported portion extends from one end to another end in a third direction orthogonal to the first direction and intersecting the second direction. The supporting portion extends from one end to another end in the second direction. The one end of the supporting portion is connected to the above-described one end of the supported portion. The supported portion is cantilevered from the supporting portion in the third direction to form a wiring space to keep the electric wire extending in the first direction. The contacting portion extends in the second direction. The second holder holds the first holder. The second holder is in contact with the contacting portion of the first holder. A distance from the reference face to a position farthest from the reference face among positions at which the contacting portion contacts the second holder is larger than a distance from the reference face to a face of the supported portion facing the reference face in the second direction.

The present disclosure described herein further provides a heating device including an electric wire, a temperature sensor, an elastic body, a first holder, and a second holder. The electric wire extends in a first direction. The temperature sensor is in contact with a target to detect a temperature of the target. The elastic body presses the temperature sensor toward the target in a second direction intersecting the first direction. The first holder holds the temperature sensor and includes a supported portion, a supporting portion, a reference face, and a contacting portion. The supported portion extends from one end to another end in a third direction orthogonal to the first direction and intersecting the second direction. The supporting portion extends from one end to another end in the second direction. The one end of the supporting portion is connected to the above-described one end of the supported portion. The supported portion is cantilevered from the supporting portion in the third direction to form a wiring space to keep the electric wire extending in the first direction. The reference face contacts said another end of the supporting portion. The contacting portion is raised from the reference face in the second direction. The second holder holds the first holder. The second holder contacts the contacting portion of the first holder. A position farthest from the reference face among positions at which the contacting portion contacts the second holder is farther from the reference face than a face of the supported portion facing the reference face in the second direction.

The present disclosure described herein still further provides a fixing device and an image forming apparatus that include the heating device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of an image forming apparatus;

FIG. 2 is a schematic diagram illustrating a configuration of a fixing device installed in the image forming apparatus of FIG. 1;

FIG. 3 is a plan view of a heater in the fixing device of FIG. 2;

FIG. 4 is a block diagram of a temperature control mechanism of the heater of FIG. 3;

FIG. 5 is a cross-sectional view of a thermistor, a thermistor holder, and a heater holder in the fixing device of FIG. 2;

FIG. 6A is a plan view of the thermistor of FIG. 5;

FIG. 6B is a rear view of the thermistor of FIG. 5;

FIG. 6C is a side view of the thermistor of FIG. 5;

FIG. 7 is a perspective view of a part of a rear side of the heater holder of FIG. 5;

FIG. 8 is a rear view of the thermistor of FIG. 5 attached to the heater holder of FIG. 5 and a part of the heater holder;

FIG. 9 is a perspective view of the thermistor holder of FIG. 5;

FIG. 10 is a perspective view of the thermistor holder of FIG. 9 attached to the heater holder of FIG. 5 and a part of the heater holder;

FIG. 11 is a rear view of the thermistor holder attached to the heater holder of FIG. 10;

FIG. 12 is a perspective view of multiple thermistor holders wiring electric wires;

FIG. 13 is a plan view of a heater including resistive heat generators different from resistive heat generators of the heater of FIG. 3;

FIG. 14 is a plan view of a heater including resistive heat generators different from resistive heat generators of the heaters of FIGS. 3 and 13;

FIG. 15 is a cross-sectional view of a fixing belt having no elastic layer;

FIG. 16 is a schematic diagram of another fixing device in which the above embodiments are applicable;

FIG. 17 is a schematic diagram of still another fixing device in which the above embodiments are applicable;

FIG. 18 is a schematic diagram of still another fixing device in which the above embodiments are applicable;

FIG. 19 is a schematic diagram of still another fixing device in which the above embodiments are applicable;

FIG. 20 is a schematic diagram of still another fixing device in which the above embodiments are applicable;

FIG. 21 is a schematic diagram of another image forming apparatus in which the above embodiments are applicable;

FIG. 22 is a diagram illustrating a configuration of a fixing device included in the image forming apparatus of FIG. 21;

FIG. 23 is a plan view of the heater illustrated in FIG. 22;

FIG. 24 is a partial perspective view of a heater holder, a thermal equalization plate, and the heater illustrated in FIG. 22;

FIG. 25 is a view to illustrate a method of attaching a connector to the heater holder illustrated in FIG. 22;

FIG. 26 is a diagram illustrating an arrangement of temperature sensors;

FIG. 27 is a schematic diagram illustrating a groove of a flange illustrated in FIG. 25;

FIG. 28 is a diagram illustrating another example of an arrangement of thermal equalization plates;

FIG. 29 is a diagram illustrating still another example of an arrangement of a thermal equalization plate;

FIG. 30 is a plan view of a heater to illustrate enlarged separation areas;

FIG. 31 is a schematic diagram of still another fixing device in which the above embodiments are applicable;

FIG. 32 is a perspective view of a heater holder, a thermal equalization plate, and a heater in the fixing device illustrated in FIG. 31;

FIG. 33 is a diagram illustrating an example of an arrangement of a first thermal equalization plate and second thermal equalization plates;

FIG. 34 is a diagram illustrating another example of an arrangement of first thermal equalization plates and second thermal equalization plates;

FIG. 35 is a diagram illustrating other examples of arrangements of a second thermal equalization plate;

FIG. 36 is a schematic diagram of a fixing device having a gap between the first thermal equalization plate and the heater holder;

FIG. 37 is a schematic diagram illustrating a two dimensional atomic crystal structure of graphene;

FIG. 38 is a schematic diagram illustrating a three dimensional atomic crystal structure of graphite; and

FIG. 39 is a schematic diagram of still another fixing device to which the above embodiments are applicable.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Referring now to the drawings, embodiments of the present disclosure are described below. Like reference signs are assigned to identical or equivalent components and a description of those components may be simplified or omitted. The following describes a fixing device incorporated in an image forming apparatus as a heating device.

### <Structure of Image Forming Apparatus>

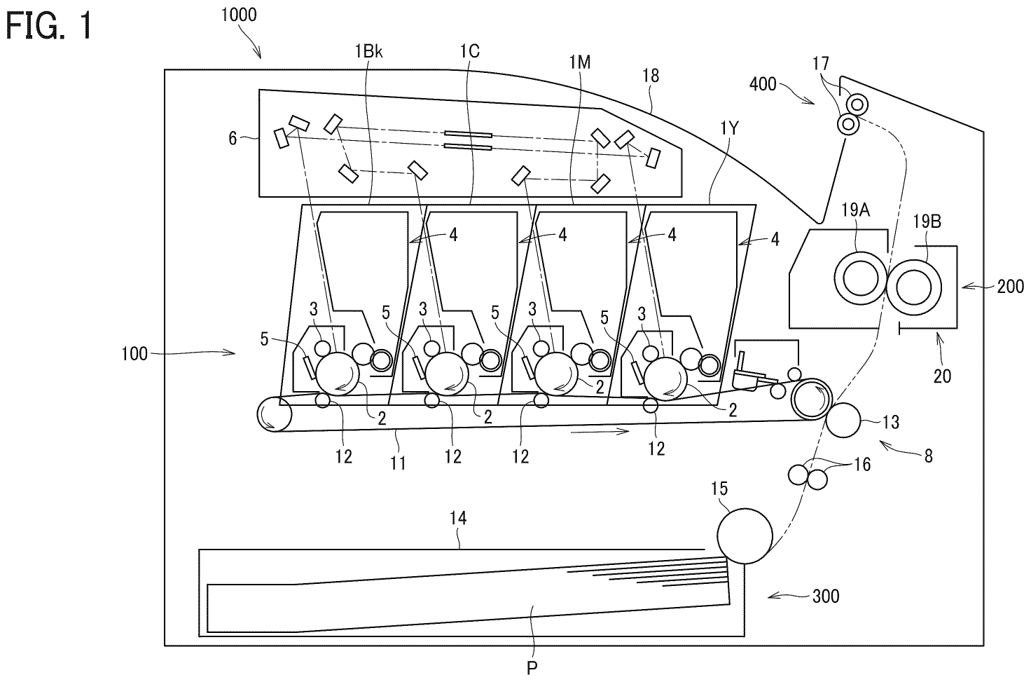

FIG. 1 is a schematic diagram illustrating a configuration of an image forming apparatus 1000. In the following description, the “image forming apparatus” includes a printer, a copier, a facsimile machine, or a multifunction peripheral having at least two of printing, copying, scanning, and facsimile functions. The term “image formation” includes the formation of images with meanings such as characters and figures and the formation of images with no meanings such as patterns. Initially, with reference to FIG. 1, a description is given below of the overall configuration and operation of the image forming apparatus 1000.

As illustrated in FIG. 1, the image forming apparatus 1000 includes an image forming section 100, a fixing section 200, a sheet feeder 300, and a sheet ejection section 400.

### (Image Forming Section)

The image forming section 100 forms an image on a sheet as a recording medium. The image forming section 100 includes four image forming units 1Y, 1M, 1C, and 1Bk, an exposure device 6, and a transfer device 8.

Each of the four image forming units 1Y, 1M, 1C, and 1Bk includes a photoconductor 2, a charger 3, a developing device 4, and a cleaner 5.

The photoconductor 2 bears an electrostatic latent image on the surface of the photoconductor 2 and rotates. Examples of the photoconductor 2 include an endless-shaped photoconductor belt in addition to a drum-shaped photoconductor.

The charger 3 charges the surface of the photoconductor 2. The charging system of the charger 3 is not limited to a particular system as long as the charger 3 applies a voltage to the surface of the photoconductor 2 to uniformly charge the surface of the photoconductor 2. The charging system of the charger 3 can be selected as appropriate depending on the purpose. Specifically, examples of the charger 3 include a contact type charger such as a conductive or semiconductive charging roller, a magnetic brush, a fur brush, a film, or a rubber blade, and a non-contact type charger using corona discharge.

The developing device 4 supplies toner as the developer to the electrostatic latent image on the photoconductor 2 to form a toner image. The developing devices 4 accommodate toners (developers) of different colors such as yellow, magenta, cyan, and black in the image forming units 1Y, 1M, 1C, and 1Bk, respectively, corresponding to color separation components of a color image.

The cleaner 5 removes the toner and other foreign matters remaining on the photoconductor 2. Examples of the cleaner 5 include a cleaning blade disposed to be in contact with the surface of the photoconductor 2.

The exposure device 6 exposes the charged surface of the photoconductor 2 to form the electrostatic latent image on the surface of the photoconductor 2.

The exposure system of the exposure device 6 is not limited to a particular system as long as the exposure device 6 can expose the charged surface of the photoconductor 2 and can be appropriately selected depending on the purpose. Specific examples of the exposure device include various exposure devices such as a copying optical system, a rod lens array system, a laser optical system, a liquid crystal shutter optical system, and an LED optical system.

The transfer device 8 transfers an image onto a sheet. The transfer device 8 includes an intermediate transfer belt 11, primary transfer rollers 12, and a secondary transfer roller 13. The intermediate transfer belt 11 is an endless belt stretched by a plurality of support rollers. Four primary transfer rollers 12 are disposed inside the loop of the intermediate transfer belt 11. Each of the primary transfer rollers 12 is in contact with the corresponding photoconductor 2 via the intermediate transfer belt 11 to form a primary transfer nip between the intermediate transfer belt 11 and each photoconductor 2. On the other hand, the secondary transfer roller 13 contacts an outer circumferential surface of the intermediate transfer belt 11 to form a secondary transfer nip between the secondary transfer roller 13 and the intermediate transfer belt 11.

### (Fixing Section)

The fixing section 200 includes a fixing device 20 that heats the sheet to fix the image on the sheet. The fixing device 20 includes a pair of rotators 19A and 19B contacting each other, and a heater heating at least one of the pair of rotators 19A and 19B.

### (Sheet Feeder)

The sheet feeder 300 supplies the sheet to the image forming section 100. The sheet feeder 300 includes a sheet tray 14 to store sheets P and a feed roller 15 to feed the sheet P from the sheet tray 14. Examples of the “sheet” include not only a sheet of paper but also an overhead projector (OHP) transparency sheet, a fabric, a metallic sheet, a plastic film, and a prepreg sheet including carbon fibers previously impregnated with resin. Examples of the “sheet” further include thick paper, a postcard, an envelope, thin paper, coated paper (e.g., coat paper and art paper), and tracing paper, in addition to plain paper.

### (Sheet Ejection Section)

The sheet ejection section 400 ejects the sheet P to the outside of the image forming apparatus 1000. The sheet ejection section 400 includes an output roller pair 17 to eject the sheet P to the outside of the image forming apparatus 1000 and an output tray 18 to place the sheet P ejected by the output roller pair 17.

### <Image Forming Operation>

With continued reference to FIG. 1, the image forming operation of the image forming apparatus 1000 is described below.

The image forming operation is started in response to an instruction from an operation panel or external terminals. In each of the image forming units 1Y, IM, 1C, and 1Bk, the photoconductor 2 starts rotating. Subsequently, the charger 3 uniformly charges the surface of the photoconductor 2 to a high electric potential. Based on image data of a document read by a document reading device or print data instructed to print by a terminal, the exposure device 6 exposes the charged surface of each of the photoconductors 2. As a result, the electric potential at an exposed portion on the surface of each of the photoconductors 2 is decreased. Thus, the electrostatic latent image is formed on the surface of each of the photoconductors 2. The developing devices 4 supply toners to the photoconductors 2, respectively, to form toner images of different colors on the photoconductors 2, respectively.

As the photoconductors 2 rotate, the toner images on the photoconductors 2 reach primary transfer nips defined by the positions of the primary transfer rollers 12, respectively. At the primary transfer nips, the toner images are transferred from the photoconductors 2 onto the intermediate transfer belt 11 driven to rotate so as to be sequentially superimposed on one another. Thus, the full-color toner image is formed on the intermediate transfer belt 11.

The image forming operation is not limited to the above-described full color image forming operation that uses all four image forming units 1Y, 1M, 1C, and 1Bk. Alternatively, the image forming apparatus 1000 can form a monochrome toner image by using any one of the four image forming units 1Y, 1M, 1C, and 1Bk, or can form a bicolor toner image or a tricolor toner image by using two or three of the image forming units 1Y, 1M, 1C, and 1Bk. After the toner image is transferred to the intermediate transfer belt 11, the cleaner 5 removes residual toner that are remained on the photoconductor 2 from the surface of the photoconductor 2. As a result, the cleaner 5 removes foreign matter such as residual toner on the photoconductor 2.

The full-color toner image transferred to the intermediate transfer belt 11 is conveyed to the secondary transfer nip defined by the secondary transfer roller 13 in accordance with rotation of the intermediate transfer belt 11. At the secondary transfer nip, the full-color toner image is transferred from the intermediate transfer belt 11 onto the sheet P. The sheet P is fed from the sheet feeder 300. After the start of the image forming operation, the feed roller 15 rotates to feed the sheet P from the sheet tray 14. Before the sheet P reaches the secondary transfer nip, the sheet P fed from the sheet tray 14 is brought into contact with a timing roller pair 16 and temporarily stopped. After the sheet P is temporarily stopped, the timing roller pair 16 is rotated at a predetermined time to convey the sheet P to the secondary transfer nip in synchronization with the full-color toner image formed on the intermediate transfer belt 11 reaching the secondary transfer nip. As a result, the full-color toner image is transferred to the sheet P.

The sheet P bearing the full-color toner image is conveyed to the fixing section 200. In the fixing section 200, the sheet P passes between the pair of rotators 19A and 19B, and thus the full-color toner image on the sheet P is heated and pressed to fix the full-color toner image to the sheet P. Then, the sheet P bearing the fixed toner image is conveyed to the sheet ejection section 400. In the sheet ejection section 400, the output roller pair 17 ejects the sheet P onto the output tray 18. Thus, a series of image forming operations is completed.

### <Configuration of Fixing Device>

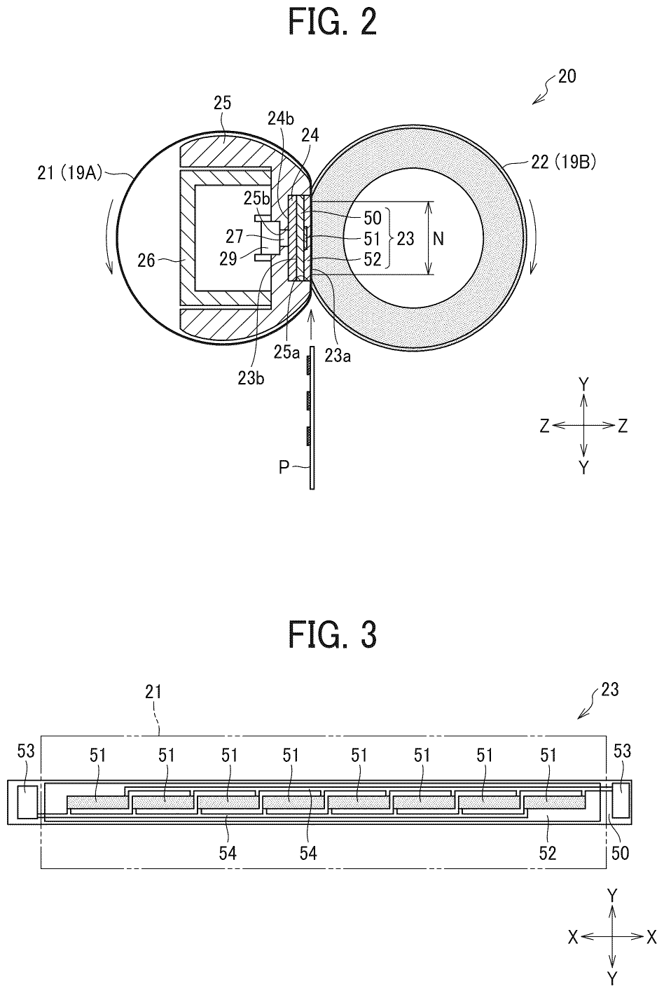

FIG. 2 is a schematic diagram illustrating a configuration of the fixing device 20. In FIG. 2, the structure of a part around a thermistor holder 29 is simplified.

As illustrated in FIG. 2, the fixing device 20 includes a heater 23, a thermal equalization plate 24 as a high thermal conductor, a heater holder 25 as a second holder, a stay 26 as a support, thermistors 27 as temperature detectors, thermistor holders 29 as first holders in addition to the pair of rotators 19A and 19B.

The pair of rotators 19A and 19B includes a first rotator 19A that is a fixing belt 21 disposed to contact an unfixed toner image on a surface of the sheet P. The pair of rotators 19A and 19B includes a second rotator 19B that is a pressure roller 22 disposed to face the fixing belt 21. A pressure member such as a spring presses the fixing belt 21 and the pressure roller 22 to be in contact with each other. As a result, a fixing nip N is formed between the fixing belt 21 and the pressure roller 22.

The fixing belt 21, the pressure roller 22, the heater 23, the thermal equalization plate 24, the heater holder 25, the stay 26, the thermistor 27, the thermistor holder 29, and the fixing device 20 extend in a direction perpendicular to the sheet surface of FIG. 2 (see a direction indicated by a double-headed arrow X in FIG. 3). The direction is referred to as a first direction in this specification and simply as a longitudinal direction below. The longitudinal direction is also a width direction of the sheet P to be conveyed, a belt width direction of the fixing belt 21, and an axial direction of the pressure roller 22. The width direction of the sheet is orthogonal to a sheet conveyance direction and a thickness direction. The vertical direction Y in FIG. 2 is referred to as a third direction in this specification and the same as the short-side direction of the heater 23, the short-side direction of the thermal equalization plate 24, the short-side direction of the thermistor 27, the short-side direction of the thermistor holder 29, the sheet conveyance direction, and the direction opposite the sheet conveyance direction. The horizontal direction Z in FIG. 2 is the thickness direction of the heater 23, the thickness direction of the thermal equalization plate 24, and a direction in which the thermistor 27 is pressed against the heater 23 and is referred to as a second direction in this specification. The directions X, Y, and Z are orthogonal to each other.

The fixing belt 21 is an endless belt including a tubular base and a release layer on an outer circumferential surface of the base. The base is made of metal such as nickel or stainless steel or resin such as polyimide. The release layer is made of, for example, tetrafluoroethylene-perfluoroalkylvinylether copolymer (PFA), polytetrafluoroethylene (PTFE), polyimide, polyetherimide, or polyether sulfide (PES). The release layer of the fixing belt 21 facilitates the separation of toner contained in the toner image from the fixing belt 21 and prevents the sheet P from adhering to and wrapping around the fixing belt 21. The fixing belt 21 may include an elastic layer between the base and the release layer. Examples of the material of the elastic layer include rubber such as silicone rubber, silicone rubber foam, and fluororubber. The elastic layer of the fixing belt 21 prevents the fixing belt 21 from forming slight surface asperities, thus facilitating uniform conduction of heat to the toner image on the sheet P to enhance fixing quality.

The pressure roller 22 includes a solid or hollow cored bar, an elastic layer on the outer circumferential surface of the cored bar, and a release layer on the outer circumferential surface of the elastic layer. The cored bar is made of metal such as iron. Examples of the material of the elastic layer include silicone rubber, silicone rubber foam, and fluororubber. The release layer is made of fluororesin such as PFA or PTFE.

The heater 23 is disposed to contact the inner circumferential surface of the fixing belt 21 at the fixing nip N. Interposing the fixing belt 21 between the heater 23 and the pressure roller 22 causes the fixing belt 21 to be pressed and forms the fixing nip N between the fixing belt 21 and the pressure roller 22. The heater 23 may be in direct contact with the inner circumferential surface of the fixing belt 21 or may be in indirect contact with the inner circumferential surface of the fixing belt 21 via a low-friction slide sheet. In the present specification, unless otherwise specified, the meaning of “contact” includes direct contact and indirect contact. In the direct contact, a first member is in contact with a second member via no member. In the indirect contact, a third member is in contact with a fourth member via a fifth member.

The heater 23 includes a base 50, resistive heat generators 51, and an insulation layer 52. The resistive heat generators 51 are disposed on the base 50 and is covered with the insulation layer 52. When power is supplied to the resistive heat generators 51, the resistive heat generators 51 generate heat. The heat is transferred to the inner circumferential surface of the fixing belt 21 via the insulation layer 52 to heat the fixing belt 21. Alternatively, the heater 23 may be turned inside out so that the base 50 is in contact with the inner circumferential surface of the fixing belt 21. In this case, since the heat of the resistive heat generators 51 is transmitted to the fixing belt 21 through the base 50, it is preferable that the base 50 be made of a material with high thermal conductivity.

The base 50 is made of material having heat resistance and insulation properties, such as ceramic such as alumina or aluminum nitride, or non-metal material such as glass or mica. Interposing another insulation layer between the base 50 and the resistive heat generators 51 enables using conductive material such as metal as the material of the base 50. Low-cost aluminum or stainless steel is favorable as the metal material of the base 50. To reduce the temperature unevenness of the heater 23 and enhance image quality, the base 50 may be made of material having high thermal conductivity, such as copper, graphite, or graphene. Graphene is formed by bonding of carbon atoms and has a sheet shape.

The resistive heat generators 51 are formed by, for example, screen-printing. The resistive heat generators 51 are produced by, for example, mixing silver-palladium (AgPd) and glass powder into a paste. The paste is coated on the base 50 by screen printing. Subsequently, the base 50 is fired to form the resistive heat generators 51. The material of the resistive heat generator 51 may contain a resistance material, such as silver alloy (e.g., AgPt) or ruthenium oxide (RuO₂) in addition to silver-palladium. The insulation layer 52 may be made of, for example, heat-resistant glass.

The thermal equalization plate 24 assists heat transfer from the heater 23. The thermal equalization plate 24 is made of a material having a higher thermal conductivity than the heater holder 25. Examples of the material of the thermal equalization plate 24 includes copper, aluminum, and graphene. For example, the thermal equalization plate 24 is made of an aluminum plate having a thickness of 0.3 mm. The heater 23 has a rotator contact face 23a contacting the inner circumferential face of the fixing belt 21 and a face 23b opposite to the rotator contact face 23a. The thermal equalization plate 24 is disposed so as to contact the face 23b. The thermal equalization plate 24 is not limited to a single-layer member and may be made of a multi-layer member.

In particular, the thermal equalization plate 24 disposed to be in direct contact with the heater 23 can effectively disperse the heat of the heater 23. The heat is less likely to be consumed in a part of the fixing nip N facing a non-sheet-passing region in which the sheet P does not pass. As a result, continuously fixing images onto the sheets P each having a width smaller than a heat generation region of the heater 23 may cause an excessive temperature rise in each of a part of the fixing belt 21 and a part of the heater 23 that face the non-sheet-passing region. The thermal equalization plate 24 can disperse the heat in the part of the fixing nip N facing the non-sheet-passing region into the entire of the thermal equalization plate 24, reducing a local temperature rise in the part of the fixing belt 21 and the part of the heater 23.

In addition, the thermal equalization plate 24 transfers the heat in the part of the fixing nip N facing the non-sheet-passing region to the sheet-passing region through which the sheet P passes, which enables effectively using the heat as a heat for the fixing process to enhance energy saving performance.

The heater holder 25 holds the heater 23 and the thermal equalization plate 24. The heater holder 25 has a recess 25a to accommodate the heater 23 and the thermal equalization plate 24. Accommodating the heater 23 and the thermal equalization plate 24 in the recess 25a of the heater holder 25 restricts the movement of the heater 23 and the movement of the thermal equalization plate 24 in the vertical direction in FIG. 2 and the direction orthogonal to the paper surface in which FIG. 2 is drawn. Since the heater holder 25 is heated to a high temperature by heat from the heater 23, the heater holder 25 is preferably made of a heat resistant material. In particular, the heater holder 25 made of heat-resistant resin having low thermal conduction, such as a liquid crystal polymer (LCP), reduces unnecessary heat transfer from the heater 23 to the heater holder 25, thus increasing the heating efficiency of the heater 23.

The heater holder 25 has through holes 25b penetrating to the back side of the heater holder 25. The through hole 25b is in a part of the recess 25a. The thermistor 27 passes through the through-hole 25b and contacts a back side 24b of the thermal equalization plate 24.

The stay 26 supports the heater holder 25. The stay 26 supports a stay side face of the heater holder 25. The stay side face is opposite a nip side face of the heater holder 25. The nip side face faces the pressure roller 22. Accordingly, the stay 26 prevents the heater holder 25 from being bent by a pressing force of the pressure roller 22. As a result, the fixing nip N having a uniform width is formed between the fixing belt 21 and the pressure roller 22. The stay 26 is preferably made of iron-based metal such as steel use stainless (SUS) or steel electrolytic cold commercial (SECC) to enhance the rigidity.

### <Operation of Fixing Device>

The fixing device 20 operates as follows.

When the image forming operation starts, a driver starts rotating the pressure roller 22 in a direction indicated by an arrow in FIG. 2, and the rotation of the pressure roller 22 rotates the fixing belt 21. A power source starts supplying power to the heater 23, and the heater 23 generates heat to heat the fixing belt 21. After the temperature of the fixing belt 21 reaches a specified target temperature, the sheet P bearing the unfixed image is conveyed to the fixing nip N between the fixing belt 21 and the pressure roller 22. As a result, the unfixed toner image on the sheet P is heated and pressed to be fixed on the sheet P. The sheet P is ejected from the fixing nip N and conveyed to the sheet ejection section 400.

### <Heater Configuration>

FIG. 3 is a plan view of the heater 23.

As illustrated in FIG. 3, the heater 23 has a long planar shape or a long plate shape extending in the X direction. The heater 23 is disposed inside the loop of the fixing belt 21 such that the longitudinal direction X of the heater 23 is along the longitudinal direction of the fixing belt 21. The “longitudinal direction of the fixing belt 21” herein means a direction orthogonal to the rotation direction of the fixing belt 21 along the outer circumferential surface of the fixing belt 21. The heater 23 includes electrodes 53 and power supply lines 54 in addition to the long base 50, the resistive heat generators 51, and the insulation layer 52.

The resistive heat generators 51 are arranged at intervals in the longitudinal direction of the base 50. A gap between neighboring resistive heat generators 51 is preferably 0.2 mm or more, more preferably 0.4 mm or more from the viewpoint of maintaining the insulation between the neighboring resistive heat generators 51. In addition, the gap between the resistive heat generators 51 adjacent to each other is preferably 5 mm or less, and is more preferably 1 mm or less, from the viewpoint of reducing temperature unevenness in the longitudinal direction because a too large gap between the resistive heat generators 51 adjacent to each other easily causes a temperature drop in the gap. Each of the resistive heat generators 51 is coupled to a pair of electrodes 53 via the power supply lines 54. In the example illustrated in FIG. 3, the pair of electrodes 53 are at both ends of the base 50 in the longitudinal direction of the base 50, and the resistive heat generators 51 are electrically coupled in parallel to the electrodes 53. The arrangement, number, shape of each of the resistive heat generators 51, the electrodes 53, and the power supply lines 54 are not limited to the example illustrated in FIG. 3 and may be appropriately changed.

The electrodes 53 and the power supply lines 54 are on the same face of the base 50 as the face on which the resistive heat generators 51 are disposed. The power supply lines 54 are covered with the insulation layer 52 in the same manner as the resistive heat generators 51 in order to obtain insulation and durability. However, the insulation layer 52 does not cover the electrodes 53 to expose the electrodes 53 so as to be connected to connectors as power feeding terminals. Connecting the connectors to electrodes 53, respectively electrically connects a power supply to each resistive heat generator 51, which enables the power supply to supply power to each resistive heat generator 51.

### <Temperature Control Mechanism>

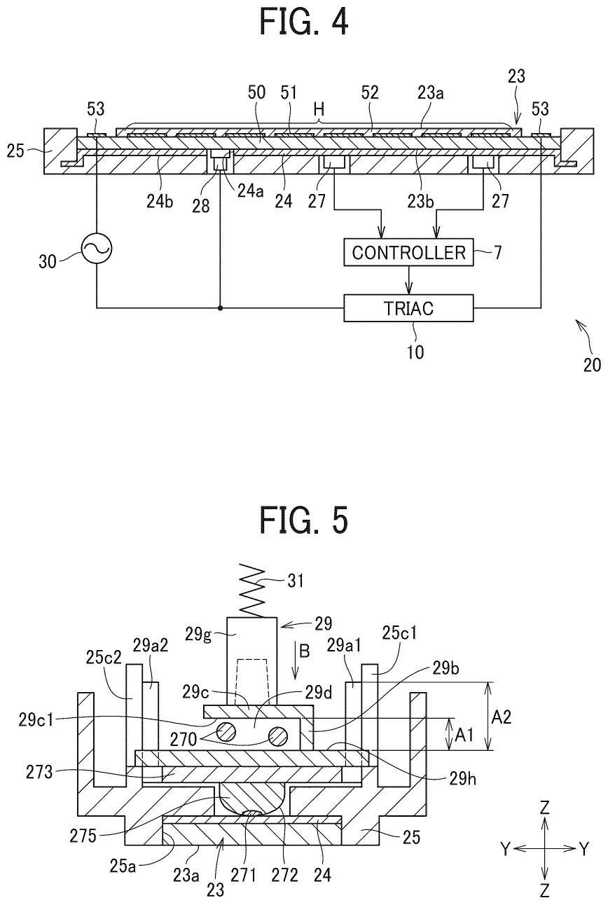

FIG. 4 is a block diagram of a temperature control mechanism of the heater 23.

As illustrated in FIG. 4, the temperature control mechanism of the fixing device 20 includes thermistors 27, a thermostat 28, a triac 10, and a controller 7 to control temperatures of the heater 23.

The thermistor 27 is a temperature sensor to control the temperature of the heater 23 and maintain the temperature of the heater 23 at a predetermined temperature. The thermostat 28 is the temperature sensor to prevent an excessive temperature rise of the heater 23, unlike the thermistor 27. In the example of FIG. 4, the thermistors 27 are disposed at the center and one end of a heat generation region of the heater 23 in the longitudinal direction, and the thermostat 28 is disposed at the other end of the heat generation region of the heater 23 in the longitudinal direction that is opposite to the one end of the heat generation region in the longitudinal direction, but the position and number of the thermistors 27 and the thermostat 28 are not limited to the example of FIG. 4 and may be appropriately changed.

Each thermistor 27 is in contact with the thermal equalization plate 24 and detects the temperature of the heater 23 via the thermal equalization plate 24. On the other hand, the thermostat 28 passes through a hole 24a of the thermal equalization plate 24 and directly contacts the back face 23b of the heater 23. The above-described configuration can enhance the response of the thermostat 28 to the temperature change of the heater 23. When the thermostat 28 detects an abnormal temperature rise of the heater 23, the thermostat 28 operates to cut off the power supply to the heater 23. However, the thermostat 28 may be configured to be in contact with the thermal equalization plate 24, similarly to the thermistor 27.

The triac 10 serves as an energization controller that controls a turn-on duty supplied from an AC power source 30 to the heater 23 based on control signals from the controller 7. The turn-on duty is defined as a ratio of a power-on time per a control cycle. The controller 7 includes a microcomputer including, for example, a central processing unit (CPU), a read-only memory (ROM), a random-access memory (RAM), and an input and output (I/O) interface. The controller 7 outputs the control signal to control the triac 10 based on the temperatures detected by the thermistors 27, and the triac 10 controls the turn-on duty based on the control signal. As a result, the temperature of the heater 23 is maintained at a predetermined target temperature.

The configurations of the heater holder 25, the thermistor 27, and the thermistor holder 29 is described below in detail.

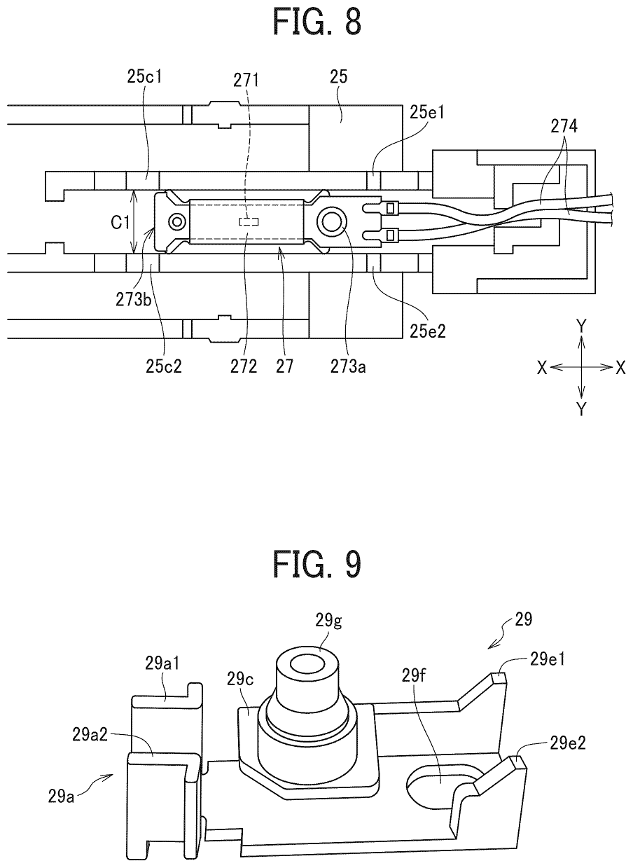

FIG. 5 is a cross-sectional view of the heater holder 25, the thermistor 27, the thermistor holder 29, and other parts in a cross section orthogonal to the longitudinal direction, which is viewed from the right side of FIG. 8. The cross section is at a position in the longitudinal direction where a heat sensitive element 271 of the thermistor 27 is disposed.

As illustrated in FIG. 5, the thermistor holder 29 is assembled to the heater holder 25 and holds one side of the thermistor 27 (that is, an upper side of the thermistor 27 in FIG. 5), and the other side of the thermistor 27 contacts the heater 23. A spring 31 as a biasing member presses the thermistor holder 29 toward the heater 23. The spring 31 is an example of an elastic body to press the thermistor holder 29 toward the heater 23 and the thermal equalization plate 24. Instead of the spring 31, rubber as the elastic body may press the thermistor holder 29 toward the heater 23 and the thermal equalization plate 24. The pressing force of the spring 31 causes the thermistor holder 29 to press (bias) the thermistor 27 in the direction indicated by the arrow B in FIG. 5 to push the heat sensitive element 271 of the thermistor 27 to the thermal equalization plate 24 via an insulation sheet 272. The thermal equalization plate 24 is a target contacted by the thermistor 27 to detect the temperature. In other words, the thermistor 27 is in contact with the thermal equalization plate 24 and detects the temperature of the thermal equalization plate 24, which enables indirectly detecting the magnitude of the temperature of the heater 23 and the fixing belt. However, the heater 23 or the fixing belt may be the target directly contacted by the thermistor 27 to detect the temperature. The thermistor 27 as the temperature sensor detects the temperature of the target.

The heat sensitive element 271 is attached to a base portion 273 via an elastic body 275. The elastic body 275 has a curved face shape protruding toward the heater 23, and the heat sensitive element 271 is held at the top of the curved face, that is, at a portion of the elastic body 275 protruding most toward the heater 23.

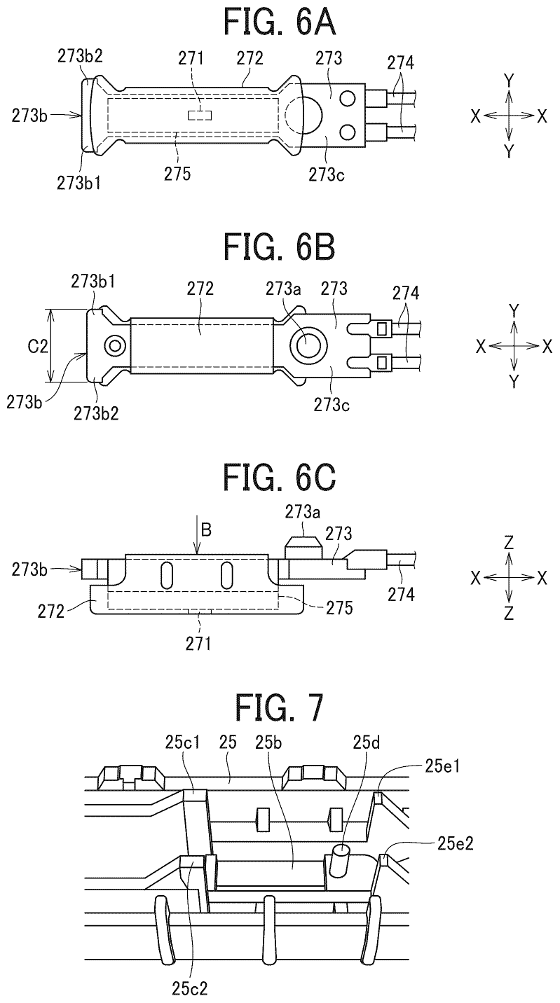

FIG. 6A is a plan view of the thermistor 27, FIG. 6B is a rear view of the thermistor 27, and FIG. 6C is a side view of the thermistor 27.

As illustrated in FIG. 6A, the thermistor 27 includes the heat sensitive element 271 as a temperature detector, the insulation sheet 272 as an insulator, the base portion 273, a harness 274, and the elastic body 275.

The base portion 273 holds the heat sensitive element 271 through the elastic body 275. The insulation sheet 272 is wound around a portion of the base portion 273 that holds the heat sensitive element 271, and the insulation sheet 272 covers the surface of the heat sensitive element 271. The examples of the elastic body 275 includes a sponge.

As illustrated in FIG. 6B, the base portion 273 includes a positioning tube 273a. The positioning tube 273a has a tubular shape having a hole extending in the Z direction, that is, a cylindrical structure. One end 273b of the thermistor 27 in the longitudinal direction extends in the Y direction and has a first projection 273b1 and a second projection 273b2 at both ends of the one end 273b in the Y direction, and the first projection 273b1 and the second projection 273b2 project outward in the Y direction, which forms T-shape. The harness 274 is connected to the other end 273c of the base portion 273. The harness 274 is fixed to the base portion 273 by, for example, soldering.

As illustrated in FIG. 6C, the pressing force of the spring 31 presses the base portion 273 in the direction indicated by the arrow B via the thermistor holder 29. As a result, the heat sensitive element 271 is pressed against the thermal equalization plate via the insulation sheet 272.

FIG. 7 is a perspective view of a rear side of the heater holder 25 to which the thermistor 27 is attached.

As illustrated in FIG. 7, the heater holder 25 includes a pair of positioning ribs 25c1 and 25c2 and a positioning pin 25d. The positioning ribs 25c1 and 25c2 and the positioning pin 25d extend outward in the Z direction (upward in FIG. 5).

FIG. 8 is a rear view of the thermistor 27 attached to the rear side of heater holder 25 and a part of the heater holder 25.

As illustrated in FIG. 8, the one end 273b of the base portion 273 of the thermistor 27 is inserted and fitted into a space between the pair of positioning ribs 25c1 and 25c2 disposed on the heater holder 25.

In addition, the positioning pin 25d (see FIG. 7) is inserted into the hole inside the positioning tube 273a of the thermistor 27 to position the thermistor 27 with respect to the heater holder 25. The thermistor 27 is positioned with respect to the heater holder 25 with a slight play. The slight play enables the thermistor 27 pressed by the thermistor holder to move toward the thermal equalization plate, which enables the heat sensitive element of the thermistor 27 to appropriately contact the thermal equalization plate. A width C1 between the positioning ribs 25c1 and 25c2 in the short-side direction is slightly larger than a width C2 (see FIG. 6B) of the one end 273b of the base portion 273.

Subsequently, the configuration of the thermistor holder 29 is described with reference to FIG. 9. FIG. 9 is a perspective view of the thermistor holder 29.

As illustrated in FIG. 9, the thermistor holder 29 includes a pair of contact ribs 29a1 and 29a2 that project in the thickness direction of the thermistor holder 29 from one end 29a of the thermistor holder 29. The pair of contact ribs 29a1 and 29a2 are disposed with a space between the contact ribs 29a1 and 29a2 in the short-side direction.

The thermistor holder 29 includes a supporting portion 29b (see FIG. 5) and a supported portion 29c. As illustrated in FIG. 5, the thermistor holder 29 has a substantially L-shaped portion. The supporting portion 29b is a portion of the L-shaped portion extending in the Z direction in FIG. 5, and the supported portion 29c is a portion of the L-shaped portion extending in the Y direction in FIG. 5. In other words, the supporting portion 29b supports one side of the supported portion 29c in the Y direction (a right end in FIG. 5). The above-described one side of the supported portion 29c in the Y direction means, for example, one of two parts of the supported portion 29c formed by dividing the supported portion 29c into two in the Y direction. In particular, the supporting portion 29b in FIG. 5 supports one end of the above-described one side of the supported portion 29c in the Y direction. In other words, one end of the supporting portion 29b is connected to the above-described one end of the supported portion 29c to support the supported portion 29c.

A wiring space 29d is formed below the supported portion 29c and adjacent to the supporting portion 29b in order to wire a harness 270. The wiring space 29d is closed at one end in the Y direction by the supporting portion 29b and is opened toward the other end in the Y direction. In other words, the thermistor holder 29 has a cantilever structure in which the supporting portion 29b supports one end of the supported portion 29c in the short-side direction. The harness 270 extends in the X direction in the wiring space 29d. The harness 270 extends from a thermistor different from the thermistor 27 held by the thermistor holder 29 illustrated in FIG. 9. In other words, the supported portion 29c is cantilevered from the supporting portion 29c in the Y direction to form the wiring space 29d to keep the harness 270 extending in the X direction.

As illustrated in FIG. 9, the thermistor holder 29 includes a biasing member mounted portion 29g on the upper face of the supported portion 29c. As illustrated in FIG. 5, one end of the spring 31 is attached to the upper portion of the biasing member mounted portion 29g.

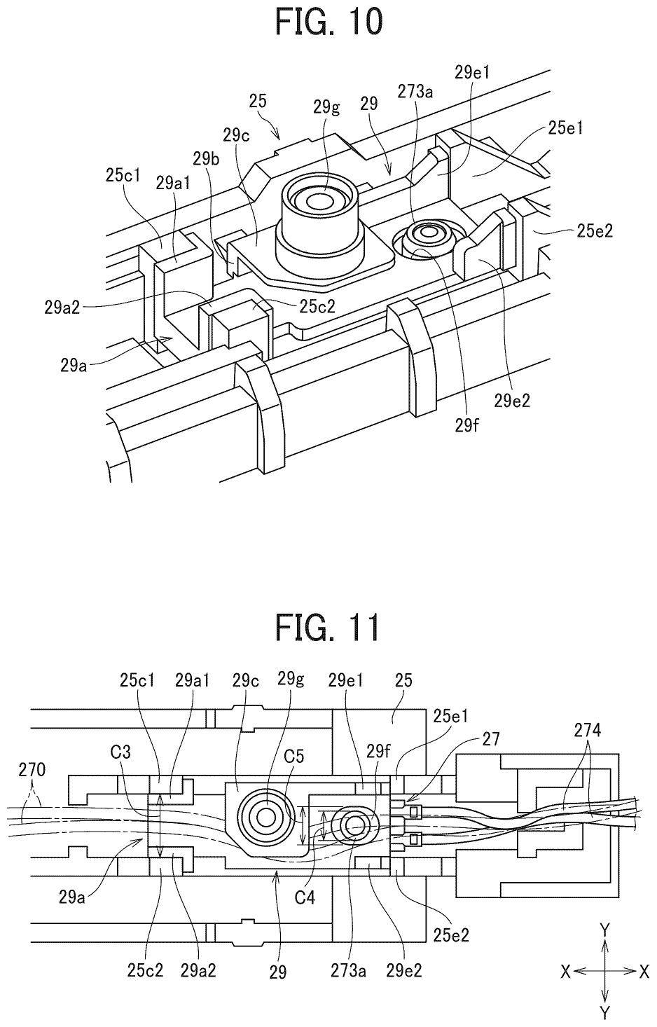

FIG. 10 is a perspective view of the thermistor holder 29 attached to the rear side of the heater holder 25, and FIG. 11 is a rear view of the thermistor holder 29 attached to the rear side of the heater holder 25.

As illustrated in FIGS. 10 and 11, one end 29a of the thermistor holder 29 in the longitudinal direction functioning as a fitting portion is fitted to the space between the pair of positioning ribs 25c1 and 25c2 of the heater holder 25. At this time, the contact rib 29a1 of the thermistor holder 29 contacts the positioning rib 25c1 of the heater holder 25, and the contact rib 29a2 contacts the positioning rib 25c2. In other words, the positioning rib 25c1 has one side and the other side in the Y direction, and the positioning rib 25c2 has one side and the other side in the Y direction. The contact rib 29a1 as a first contacting portion contacts the one side of the positioning rib 25c1 as a first contacted portion in the Y direction, and the contact rib 29a2 as a second contacting portion contacts the other side of the positioning rib 25c2 as a second contacted portion in the Y direction. Each of the contact ribs 29a1 and 29a2 has a substantially L-shape having a portion extending in the X direction and a portion extending in the Y direction. The portion of the contact rib 29a1 extending in the X direction contacts the above-described one side of the positioning rib 25c1 in the Y direction, and the portion of the contact rib 29a2 extending in the X direction contacts the above-described the other side of the positioning rib 25c2. Accordingly, each of the contact ribs 29a1 and 29a2 may have the portion extending in the X direction and not have the portion extending in the Y direction. For the sake of simplicity, FIG. 5 is a sectional view in a cross section including the portions of the contact ribs 29a1 and 29a2 extending in the direction X and not including the portions of the contact ribs 29a1 and 29a2 extending in the Y direction.

The positioning tube 273a of the thermistor 27 is inserted into a positioning hole 29f of the thermistor holder 29 to position the thermistor 27 with respect to the thermistor holder 29. As described above, the positioning hole 29f and the positioning tube 273a serve as positioning portions of the thermistor holder 29 and the thermistor 27.

As illustrated in FIG. 11, a width C5 of the positioning hole 29f in the short-side direction is larger than an outer diameter C4 of the positioning tube 273a, and the thermistor 27 has a positioning play by the length of C5−C4 so as to be movable relative to the thermistor holder 29 in the short-side direction. The width C3 of the one end 29a of the thermistor holder 29 is smaller than the width C1 between the positioning ribs 25c1 and 25c2 (see FIG. 8), and the thermistor holder 29 has a positioning play by the length of C1−C3 so as to be movable relative to the heater holder 25 in the short-side direction.

As described above, the one end 29a of the thermistor holder 29 and the positioning ribs 25c1 and 25c2 serve as positioning portions of the thermistor holder 29 and the heater holder 25.

In the above, the widths C1, C3, and C5 and the outer diameter C4 are designed to satisfy C5−C4>C3−C1. As a result, the positioning play of the thermistor holder 29 with respect to the heater holder 25 in the short-side direction is smaller than the positioning play of the thermistor 27 with respect to the thermistor holder 29 in the short-side direction. In other words, the positioning play between the thermistor holder 29 as the first holder and the heater holder 25 as the second holder in the short-side direction as the third direction is smaller than the positioning play between the thermistor holder 29 as the first holder and the thermistor 27 as the temperature sensor in the short-side direction as the third direction. Thus, even when the thermistor holder 29 moves in the short-side direction with respect to the heater holder 25, one of both end faces forming the positioning hole 29f of the thermistor holder 29 does not interfere with the positioning tube 273a of the thermistor 27 in the short-side direction. As a result, when the thermistor holder 29 presses the thermistor 27 in the direction indicated by the arrow B in FIG. 5, the thermistor holder 29 does not hinder the movement of the thermistor 27 in the direction indicated by the arrow B, which enables the heat sensitive element to appropriately contact the thermal equalization plate.

The harness 270 is routed in the longitudinal direction and passes through the wiring space below the supported portion 29c of the thermistor holder 29 in the X direction. The meaning of “the harness 270 passes through the wiring space in the X direction” is not limited to “the harness 270 is wired strictly in parallel to the X direction” and includes the harness 270 meandering as illustrated in FIG. 11.

The above-described fixing device has an issue that the positional deviation of the thermistor holder 29 adversely affects the detection accuracy of the thermistor 27. As illustrated in FIG. 5, the thermistor holder 29 has the cantilever structure having the wiring space 29d opened to the other end in the short-side direction. As described above, the thermistor holder 29 has the play in the short-side direction with respect to the heater holder 25. Applying a force to the thermistor holder 29 in the above-described structure is likely to incline the thermistor holder 29 in the short-side direction. Since the heat sensitive element 271 of the thermistor 27 is at the top of the curved elastic body 275, the inclination of the thermistor 27 caused by the inclination of the thermistor holder 29 in the short-side direction increases the inclination of the heat sensitive element 271. As a result, the thermistor 27 does not appropriately contact the thermal equalization plate 24, and the thermistor 27 cannot appropriately detect the temperature of the heater 23 via the thermal equalization plate 24.

To countermeasure the above issue, the thermistor holder 29 in the present embodiment includes the contact ribs 29a1 and 29a2 extending in the direction indicated by the arrow B in FIG. 5 that is the direction in which the thermistor holder 29 presses the thermistor 27, the vertical direction in FIG. 5, and the direction intersecting the short-side direction, which is also referred to simply as a pressing direction, and the heater holder 25 includes the positioning ribs 25c1 and 25c2 extending in the same direction as the pressing direction and contacting the contact ribs 29a1 and 29a2, respectively. The above-described structure can minimize the backlash of the thermistor holder 29 having the play with respect to the heater holder 25, and the heat sensitive element 271 of the thermistor 27 can appropriately contact the thermal equalization plate 24. As a result, the thermistor 27 can accurately detect the temperature of the thermal equalization plate 24. The expression “the contact ribs 29a1 and 29a2 and the positioning ribs 25c1 and 25c2 extend in the direction in which the thermistor holder 29 presses the thermistor 27” allows some errors and does not mean that the contact ribs 29a1 and 29a2 and the positioning ribs 25c1 and 25c2 extend in a direction strictly parallel to the direction.

In particular, as illustrated in FIG. 5, a contact height A2 defined by portions in which the positioning ribs 25c1 and 25c2 contact the contact ribs 29a1 and 29a2, which reduce the backlash in the short-side direction, is set to be higher than a height A1 of the wiring space 29d to route the harness 270. Even if the work of routing the harness 270 to wire the harness 270 in the wiring space 29d generates a force applied from the harness 270 to the thermistor holder 29, the positioning ribs 25c1 and 25c2 contacting the contact ribs 29a1, 29a2 at higher positions than a position at which the force is applied the thermistor holder 29 can reduce the inclination of the thermistor holder 29 in the short-side direction. As a result, the heat sensitive element 271 can appropriately contact the thermal equalization plate 24, and the thermistor 27 can accurately detect the temperature of the heater 23.

The above-described height means a distance in the Z direction from a reference face 29h on which the supporting portion 29b of the thermistor holder 29 is disposed toward the supported portion 29c. One end of the supporting portion 29b is connected to one end of the supported portion 29c, and the other end of the supporting portion 29b contacts the reference face 29h. The height A1 means a distance from the reference face 29h to the highest position of the wiring space 29d. In the present embodiment, the height A1 means the height from the reference face 29h to the lower face 29c1 of the supported portion 29c. The lower face 29c1 of the supported portion 29c faces the reference face 29h. The contact ribs 29a1 and 29a2 are raised from the reference face 29h in the Z direction. The contact height A2 means a height from the reference face 29h to the highest position in the portions where the positioning ribs 25c1 and 25c2 and the contact ribs 29a1 and 29a2 are in contact with each other. When the reference face 29h has irregularities, for example, the height may be a distance from the lowest position of the reference face 29h (the position farthest from the supported portion 29c in the Z direction). In this case, the height A1 may be a distance from the lowest position to a position where a perpendicular line extended from the lowest position in the Z direction abuts on the lower face 29c1 of the supported portion 29c. The height is not limited to be a distance from the reference face 29h.

For example, the heater 23 (a heating body) has the rotator contact face 23a (the face heating the fixing belt) opposite to a face in which the thermistor 27 contacts. The reference face may be the rotator contact face 23a, and the height may be a distance from the rotator contact face 23a. In this case, a distance from the rotator contact face 23a as the reference face to a position farthest from the rotator contact face 23a among positions at which the contact ribs 29a1 and 29a2 contact the positioning ribs 25c1 and 25c2 of the heater holder 25 as the second holder is larger than a distance from the rotator contact face 23a to the lower face 29c1 of the supported portion 29c in the Z direction.

The height in this specification means a length in the Z direction of FIG. 5, the direction from the supporting portion 29b to the supported portion 29c, and the direction from a lower part to an upper part in FIG. 5. Whether the contact height is higher than the wiring space may be determined based on whether the position at which the contacting portion of the thermistor holder 29 as the first holder is in contact with the heater holder 25 as the second holder is higher than the highest position of the lower face 29c1 of the supported portion 29c. In other words, the inclination of the thermistor holder 29 in the short-side direction is reduced when a position farthest from the reference face 29h among positions at which the contact ribs 29a1 and 29a2 contact the heater holder 25 as the second holder is farther from the reference face 29h than the lower face 29c1 of the supported portion 29c in the Z direction.

The contact height A2 means the contact height of the contact rib 29a1 closest to the supporting portion 29b in the Y direction among the contacting portions in which the thermistor holder 29 as the first holder contacts the heater holder 25 as the second holder. However, the fixing device may have multiple contacting portions as in the present embodiment. In this case, the second contacting portion is preferably disposed like the contact rib 29a2 in the present embodiment. In other words, the second contacting portion is preferably disposed adjacent to the opening of the wiring space 29d, that is, closer to the one end of the supported portion 29c that is opposite to the other end of the supported portion 29c connected to the supporting portion 29b than the first contacting portion.

The thermistor holder 29 is held by the heater holder 25 and has the positioning play in the Y direction with respect to the heater holder 25. Accordingly, the contact ribs 29a1 and 29a2 of the thermistor holder 29 do not always contact the positioning ribs 25c1 and 25c2 after the thermistor holder 29 is assembled to the heater holder 25. The contacting portion of the first holder is disposed to be contactable with the second holder when the first holder is moved by the amount of the positioning play in the Y direction with respect to the second holder. The contact height of the contacting portion means a height at which the contacting portion comes into contact with the second holder when the first holder is moved toward the second holder by the amount of the positioning play in the Y direction. Moving the first holder toward the second holder in the Y direction by the amount of the positioning play causes the contacting portion not contacting the second holder to be in contact with the second holder, which restricts the first holder not to further move toward the second holder.

The contact ribs 29a1 and 29a2 are preferable to contact the positioning ribs 25c1 and 25c2, respectively. In other words, the thermistor holder 29 preferably has one end contacting the heater holder and the other end contacting the heater holder in the short-side direction because both ends of the thermistor holder in the short-side direction contact the heater holder to reduce the inclination of the thermistor holder 29. However, the contacting portion may be at one of both ends of the first holder and contact the contacted portion.

In the present embodiment, the above-described one end 29a of the thermistor holder 29 has the contact ribs 29a1 and 29a2 and is fitted to the space between the positioning ribs 25c1 and 25c2. In other words, a portion including the contacting portion of the thermistor holder 29 is the fitting portion fitted to the heater holder 25. The above-described structure enables the contacting portion to accurately contact the contacted portion. However, the fixing device may have a configuration including the contact ribs 29a1 and 29a2 that simply contact both sides of the heater holder 25 in the short-side direction to reduce the inclination of the thermistor holder 29 in the short-side direction.

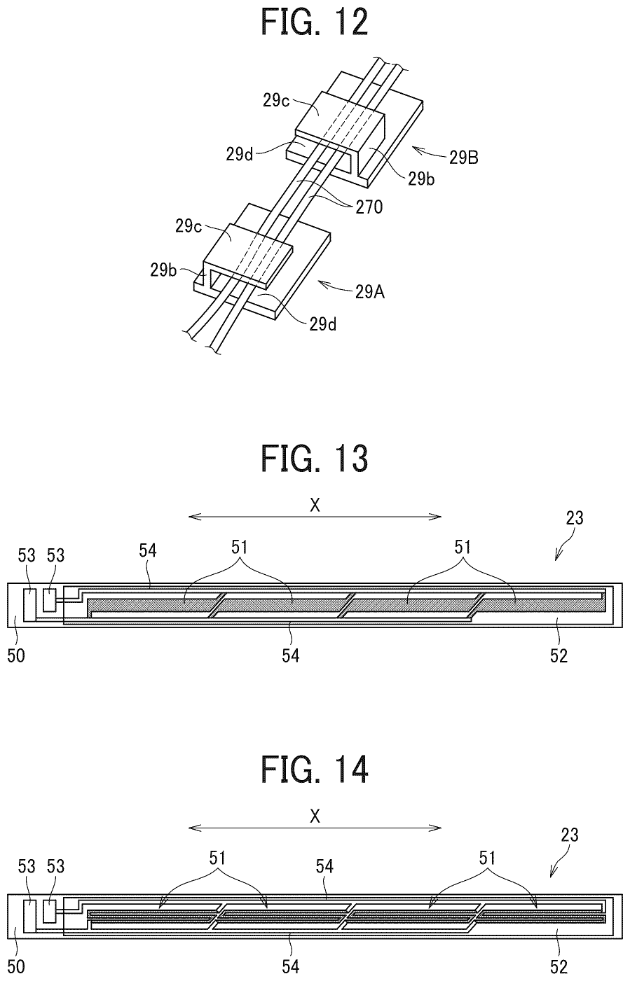

In the above description, the fixing device includes two thermistors 27, but the thermistor holder 29 holding one of the two thermistors 27 has been described. The fixing device may include another thermistor holder 29 holding the other one of the two thermistors 27. In this case, as illustrated in FIG. 12, one opening of the wiring space 29d below the supported portion 29c in one thermistor holder 29A preferably opens toward a direction opposite a direction in which the other opening of the wiring space 29d below the contacted portion 29c in the other thermistor holder 29B opens. In other words, an opening direction of the wiring space 29d in the one thermistor holder 29A is preferably opposite to an opening direction of the wiring space 29d in the other thermistor holder 29B. The above-described structure can prevent the harness 270 from being detached from the wiring space below the supported portion 29c.

As illustrated in FIG. 9, the thermistor holder 29 of the above embodiment includes a pair of contact ribs 29e1 and 29e2 as contacting portions contacting the heater holder 25 at both ends of the thermistor holder 29 in the short-side direction. The thermistor holder 29 includes the contact ribs 29a1 and 29a2 at one end of the thermistor holder 29 (the left end in FIG. 9) and the contact ribs 29e1 and 29e2 at the other end of the thermistor holder 29 in the longitudinal direction. The contact ribs 29e1 and 29e2 extend in the X direction, similarly to the contact ribs 29a1 and 29a2. As illustrated in FIGS. 10 and 11, the contact ribs 29e1 and 29e2 are in contact with contacted ribs 25e1 and 25e2 of the heater holder 25 in the X direction, respectively. However, the contact ribs 29e1 and 29e2 may have the same shape as the contact ribs 29a1 and 29a2 and contact the contacted ribs 25e1 and 25e2 in the Y direction, respectively. As described above, the thermistor holder 29 includes portions extending in the pressing direction at both ends in the longitudinal direction, and the portions of the thermistor holder 29 extending in the pressing direction contact portions of the heater holder 25 extending in the pressing direction, respectively. As a result, the inclination of the thermistor holder 29 in the short-side direction can be further reduced.

However, the above-described contacting structure may not be at both ends of the thermistor holder 29 in the longitudinal direction. The contacting structure may be at one of both ends of the thermistor holder 29 or the center of the thermistor holder 29 in the longitudinal direction. The contact ribs 29a1 and 29a2 are on one end of the thermistor holder 29 in the longitudinal direction, and the contact ribs 29e1 and 29e2 are on the other end of the thermistor holder 29 in the longitudinal direction. In the above, the one end and the other end may be, for example, two regions obtained by dividing the thermistor holder 29 into two in the longitudinal direction.

The above-described embodiments are illustrative and do not limit this disclosure. It is therefore to be understood that within the scope of the appended claims, numerous additional modifications and variations are possible to this disclosure otherwise than as specifically described herein.

The resistive heat generator 51 is not limited to the rectangular shape as illustrated in FIG. 3. The resistive heat generator 51 may be a parallelogram as illustrated in FIG. 13 or a folded shape as illustrated in FIG. 14. As illustrated in FIGS. 13 and 14, the pair of electrodes 53 may be at one of both ends of the base 50 in the longitudinal direction X of the heater 23.

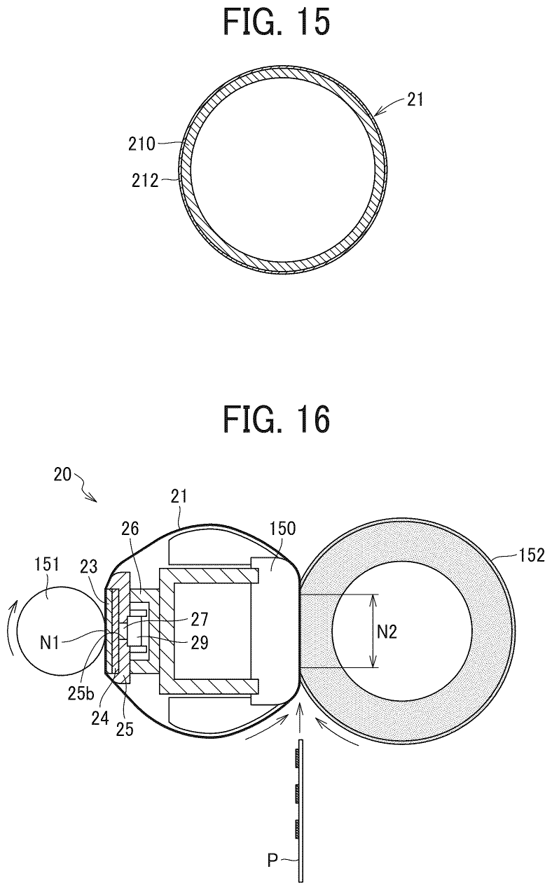

The above-described configurations are also suitable for the fixing device including the fixing belt 21 that does not include the elastic layer as illustrated in FIG. 15. The fixing belt 21 illustrated in FIG. 15 includes a base layer 210 and a surface layer 212 that is the release layer on the outer peripheral surface of the base layer 210 and does not include an elastic layer such as a rubber layer between the surface layer 212 and the base layer 210. The thermal insulation property of the fixing belt illustrated in FIG. 15 is lower than that of the fixing belt including the elastic layer. In other words, the fixing belt 21 illustrated in FIG. 15 has high thermal conductivity to transfer heat from the heater to the outer peripheral surface of the fixing belt as compared with the fixing belt including the elastic layer. However, on the other hand, such a configuration tends to remarkably increase the temperature rise in the non-sheet-passing region of the fixing belt 21. Accordingly, using the heater holder 25, the thermistor 27, and the thermistor holder 29 described in the above embodiments are preferable to appropriately detect the temperature by the thermistor to appropriately perform the temperature management of the fixing belt 21.

The above-described embodiments are also applicable to fixing devices having configurations as illustrated in FIGS. 16 to 18 in addition to the fixing device 20 illustrated in FIG. 2. The configurations of fixing devices illustrated in FIGS. 16 to 18 are described below. In FIGS. 16 to 18, like reference signs are given to elements similar to those of the fixing device 20 illustrated in FIG. 2 and overlapping description may be simplified or omitted as appropriate.

In the fixing device 20 illustrated in FIG. 16, a heating nip portion N1 and a fixing nip N2 are formed at different positions. Specifically, the fixing device 20 includes a small pressure roller 151 and a large pressure roller 152 that contact the fixing belt 21 so as to face each other and form a heating nip N1 and a fixing nip N2. The heater 23 is in contact with the pressure roller 151 at the left side in FIG. 16 via the fixing belt 21 to form the heating nip N1. A nip formation pad 150 is in contact with the pressure roller 152 at the right side in FIG. 16 via the fixing belt 21 to form the fixing nip N2. In this case, the heater 23 generates heat to heat the fixing belt 21 in the heating nip N1. The sheet P enters the fixing nip N2, and an unfixed image on the sheet P is heated and pressed to fix the image on the sheet P.

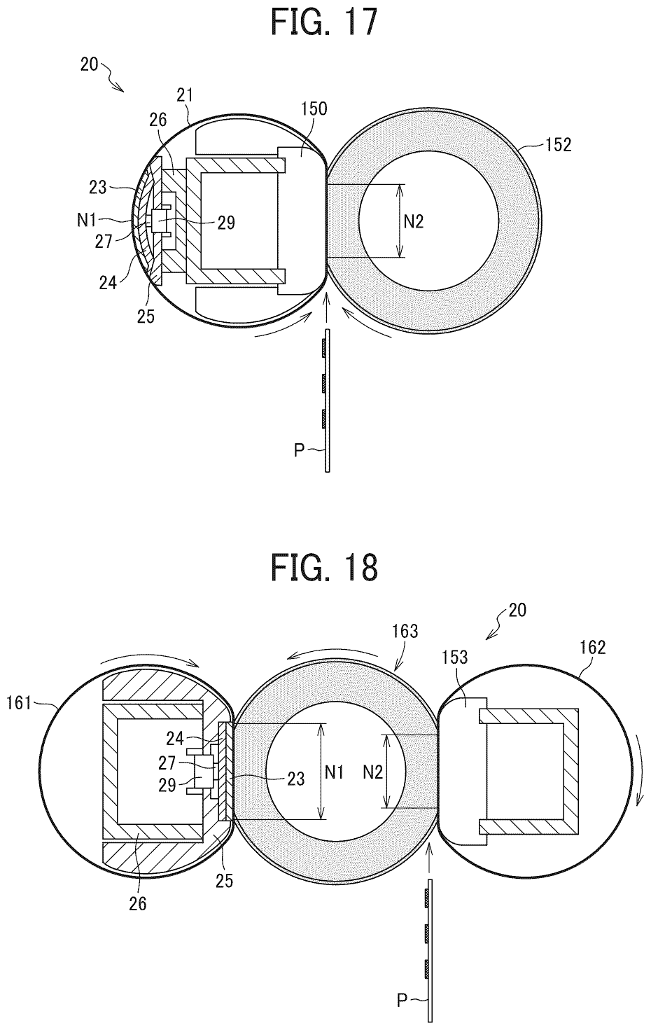

Subsequently, the fixing device in an example illustrated in FIG. 17 omits the above-described pressure roller 151 disposed at the left side in FIG. 16 and includes the heater 23 formed to be arc having a curvature of the fixing belt 21. Other parts of the fixing device illustrated in FIG. 17 are the same as the fixing device 20 illustrated in FIG. 16. In this case, the arc-shaped heater 23 surely maintains a length of the contact area between the fixing belt 21 and the heater 23 in a belt rotation direction to efficiently heat the fixing belt 21.

Subsequently, the fixing device 20 illustrated in FIG. 18 is described. The fixing device 20 illustrated in FIG. 18 includes a center roller 163 between a pair of belts 161 and 162. The heater 23 is disposed inside the loop of the left belt 161 in FIG. 18, and the left belt 161 is sandwiched by the center roller 163 and the heater 23 to form the heating nip N1. A nip formation pad 153 is disposed inside the loop of a right belt 162 in FIG. 18, and the right belt 162 is sandwiched by the center roller 163 and the nip formation pad 153 to form the fixing nip N2. In this case, the heater 23 generates heat to heat center roller 163 in the heating nip N1. The sheet P enters the fixing nip N2, and an unfixed image on the sheet P is heated and pressed to fix the image on the sheet P.

The configurations of the heater holder 25, the thermistor 27, and the thermistor holder 29 in the above-described embodiments may be applied to the fixing devices illustrated in FIGS. 16 to 18 and described above. As a result, the inclination of the thermistor holder 29 is reduced, and the thermistor 27 can accurately detect the temperature.

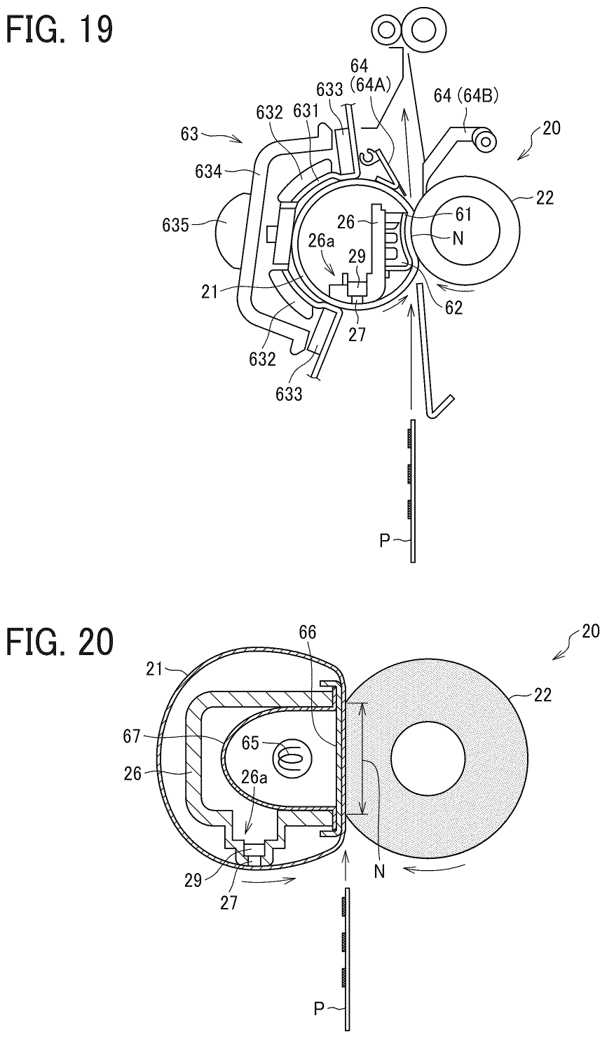

Subsequently, the fixing device 20 illustrated in FIG. 19 includes an electromagnetic induction heating (IH) heater 63 as a unit for heating the fixing belt 21. The fixing device 20 includes the fixing belt 21, the pressure roller 22, the stay 26, the thermistor holder 29, the nip formation pad 62, the slide sheet 61, the thermistor 27, and a separation plate 64A and a separation claw 64B as a separation member 64, in addition to the IH heater 63.

The IH heater 63 is disposed outside the fixing belt 21 and fixed to an image forming apparatus main body. The IH heater 63 includes a coil 632, cores 633, 634, and 635, and a coil holder 631. The coil holder 631 holds the coil 632. Supplying electric power to the coil 632 generates a magnetic field around the coil 632, and the magnetic field generates an eddy current in the metallic belt base of the fixing belt 21. The generated eddy current and the electric resistance of the belt base generates Joule heat. As a result, the fixing belt 21 generates heat. The cores 633, 634, and 635 are made a ferromagnetic material to form magnetic paths through which the magnetic field (magnetic fluxes) generated by the coil 632 passes.

The thermistor 27 is in contact with the inner circumferential surface of the fixing belt 21 to detect the temperature of the fixing belt 21.

A nip formation pad 62 contacts the pressure roller 22 via the fixing belt 21 to form the fixing nip N between the fixing belt 21 and the pressure roller 22. A slide sheet 61 containing lubricant is between the fixing belt 21 and the nip formation pad 62. Interposing the slide sheet 61 and the lubricant between the fixing belt 21 and the nip formation pad 62 reduces the sliding resistance between the fixing belt 21 and the nip formation pad 62.

The stay 26 is a holding member that holds the thermistor 27 and the thermistor holder 29 in addition to the nip formation pad 62. The stay 26 includes a holder portion 26a that holds the thermistor holder 29 and the thermistor 27.

The above-described fixing device illustrated in FIG. 19 may include the thermistor 27 and the thermistor holder 29 in the above-described embodiments, and the portion of the above-described heater holder holding the thermistor holder 29 (see FIG. 7) may be applied to the holder portion 26a of the stay 26. As a result, the inclination of the thermistor holder 29 is reduced, and the thermistor 27 can accurately detect the temperature. However, the thermistor 27 of the present embodiment is different from the above-described embodiment in that the thermistor 27 is in contact with the inner circumferential surface of the fixing belt 21 via the stay 26 to detect the temperature of the fixing belt 21.

Subsequently, the fixing device 20 illustrated in FIG. 20 includes a halogen heater 65 as a unit for heating the fixing belt 21. The fixing device 20 includes the fixing belt 21, the pressure roller 22, the stay 26, a nip formation pad 66, a reflector 67, the thermistor 27, and the thermistor holder 29, in addition to the halogen heater 65.

A nip formation pad 66 contacts the pressure roller 22 via the fixing belt 21 to form the fixing nip N between the fixing belt 21 and the pressure roller 22. In this case, since the halogen heater 65 is disposed inside the loop of the fixing belt 21 to face the nip formation pad 66, the nip formation pad 66 is irradiated with the infrared light emitted from the halogen heater 65. As a result, the nip formation pad 66 is heated, and the heat of the nip formation pad 66 transfers to the fixing belt 21 at the fixing nip N to heat the fixing belt 21. The nip formation pad 66 is preferably made of material having a higher thermal conductivity than the stay 26 so as to efficiently transfer heat to the fixing belt 21. Examples of the material of the nip formation pad 66 include copper and aluminum.

A reflector 67 inside the loop of the fixing belt 21 reflects a part of the infrared light emitted from the halogen heater 65 to the nip formation pad 66. As a result, the nip formation pad 66 is effectively heated. The reflector 67 interposed between the stay 26 and the halogen heater 65 prevents the halogen heater 65 from irradiating the stay 26 with the infrared light and reduces heat transfer from the halogen heater 65 to the stay 26, giving an energy saving effect.

The thermistor 27 is in contact with the inner circumferential surface of the fixing belt 21 to detect the temperature of the fixing belt 21.

The stay 26 is a holding member that holds the thermistor 27 and the thermistor holder 29 in addition to the nip formation pad 66 and the reflector 67. The stay 26 includes a holder portion 26a that holds the thermistor holder 29 and the thermistor 27.

The above-described fixing device illustrated in FIG. 20 may include the thermistor 27 and the thermistor holder 29 in the above-described embodiments, and the portion of the above-described heater holder holding the thermistor holder 29 (see FIG. 7) may be applied to the holder portion 26a of the stay 26. As a result, the inclination of the thermistor holder 29 is reduced, and the thermistor 27 can accurately detect the temperature.

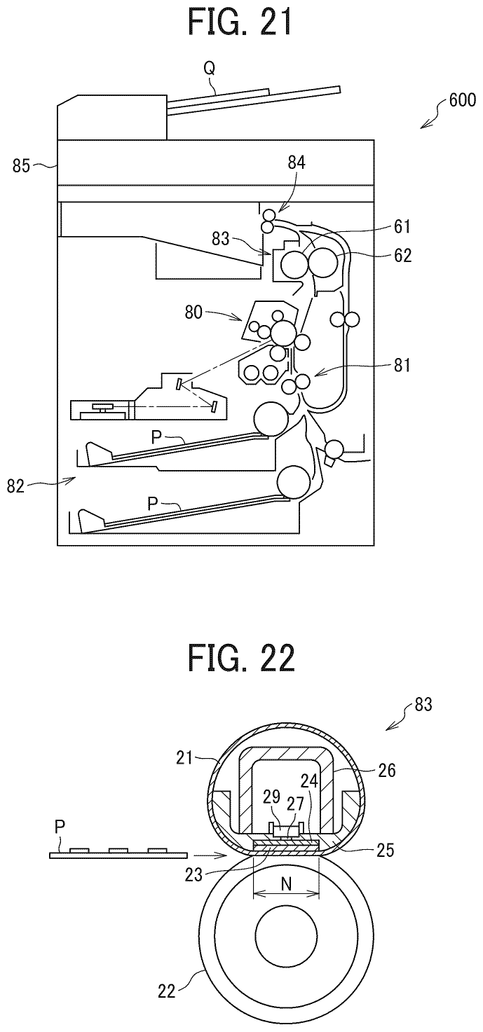

The image forming apparatus to which the embodiments of the present disclosure are applied is not limited to the image forming apparatus illustrated in FIG. 1, and the embodiments of the present disclosure may be applied to an image forming apparatus 600 as illustrated in FIG. 21. The following describes the image forming apparatus to which the present embodiments may be applied.

The image forming apparatus 600 illustrated in FIG. 21 includes an image forming device 80 including a photoconductor drum and other parts, a sheet conveyer including a timing roller pair 81, a sheet feeder 82, a fixing device 83, a sheet ejection device 84, and a reading device 85. The sheet feeder 82 includes a plurality of sheet feeding trays, and the sheet feeding trays store sheets of different sizes, respectively.

The reading device 85 reads an image of an original document Q. The reading device 85 generates image data from the read image. The sheet feeder 82 stores the plurality of sheets P and feeds the sheet P to the conveyance path. The timing roller pair 81 conveys the sheet P on the conveyance path to the image forming device 80.

The image forming device 80 forms a toner image on the sheet P. Specifically, the image forming device 80 includes the photoconductor drum, a charging roller, the exposure device, the developing device, a supply device, a transfer roller, the cleaning device, and a discharger. The fixing device 83 heats and presses the toner image to fix the toner image on the sheet P. Conveyance rollers convey the sheet P on which the toner image has been fixed to the sheet ejection device 84. The sheet ejection device 84 ejects the sheet P to the outside of the image forming apparatus 600.

The configuration of the fixing device 83 illustrated in FIG. 21 is described below with reference to FIG. 22. In FIG. 22, components common to those of the fixing device 20 illustrated in FIG. 2 are denoted by like reference signs, and overlapping description may be simplified or omitted as appropriate.

The fixing device 83 illustrated in FIG. 22 includes the fixing belt 21, the pressure roller 22, the heater 23, the thermal equalization plate 24, the heater holder 25, the stay 26, the thermistor 27, the thermistor holder 29.

The nip N is formed between the fixing belt 21 and the pressure roller 22. The nip width of the nip N is 10 mm, and the linear velocity of the fixing device 83 is 240 mm/s.

The fixing belt 21 includes a polyimide base layer and the release layer and does not include the elastic layer. The release layer is made of a heat-resistant film material made of, for example, fluororesin. The outer loop diameter of the fixing belt 21 is about 24 mm.

The pressure roller 22 includes the core, the elastic layer, and the release layer. The pressure roller 22 has an outer diameter of 24 mm to 30 mm, and the elastic layer has a thickness of 3 mm to 4 mm.

The heater 23 includes the base, a thermal insulation layer, a conductor layer including the resistive heat generators, and the insulation layer, and is formed to have a thickness of 1 mm as a whole. The width of the heater 23 in the sheet conveyance direction is, for example, 13 mm.

The heater 23 has one face contacting the inner circumferential surface of the fixing belt 21 and the other face opposite the one face. The thermal equalization plate 24 made of a high thermal conductor is disposed in contact with the other face of the heater 23. The heater holder 25 holds the heater 23 and the thermal equalization plate 24. The heater holder 25 is supported by the stay 26.

The configurations of the heater holder 25, the thermistor 27, and the thermistor holder 29 in the above-described embodiments may be applied to the above-described fixing devices illustrated in FIG. 22. As a result, the inclination of the thermistor holder 29 is reduced, and the thermistor 27 can accurately detect the temperature.

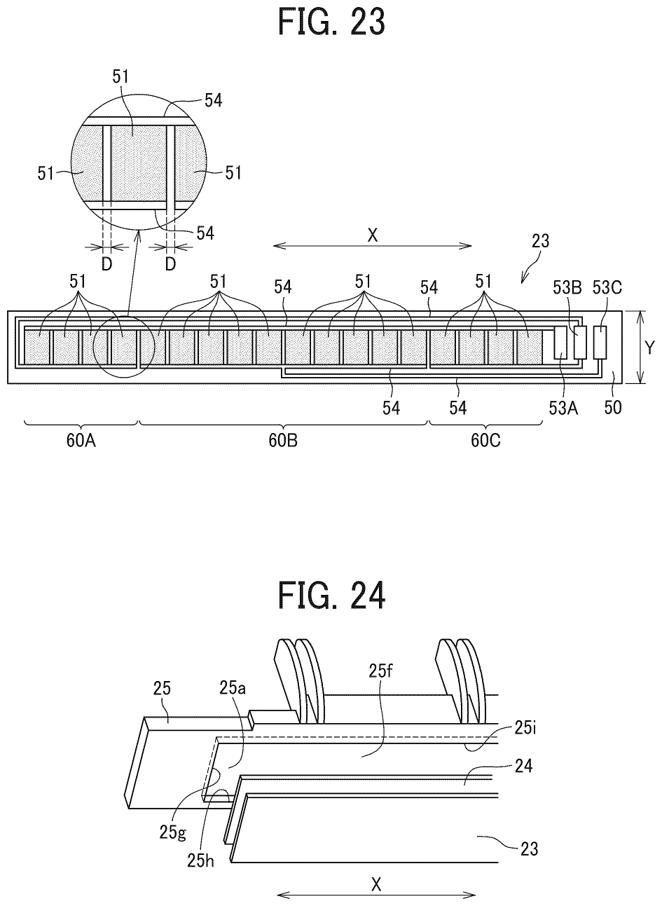

As illustrated in FIG. 23, the conductor layer of the heater 23 includes the resistive heat generators 51, the power supply lines 54, and electrodes 53A to 53C. The resistive heat generators 51 are arranged at intervals in the longitudinal direction of the heater 23. In the following description, a portion between the neighboring resistive heat generators 51 is referred to as a separation area B. As illustrated in an enlarged view of FIG. 23, the separation area B is formed between the neighboring resistive heat generators of the resistive heat generators 51. The enlarged view of FIG. 23 illustrates two separation areas B, but the separation area B is formed between neighboring resistive heat generators of all the resistive heat generators 51. In FIG. 23, the direction indicated by the arrow Y is the same as a direction intersecting an arrangement direction of the resistive heat generators 51, the short-side direction of the heater 23, and the sheet conveyance direction of the sheet passing through fixing device.

The heater 23 includes a central heat generation portion 60B and end heat generation portions 60A and 60C at both sides of the central heat generation portion 60B. The central heat generation portion 60B and the end heat generation portions 60A and 60C are configured by the resistive heat generators 51. The end heat generation portions 60A and 60C can generate heat separately from the central heat generation portion 60B. For example, choosing the left electrode 53A and the central electrode 53B of the three electrodes 53A to 53C and applying a voltage between the left electrode 53A and the central electrode 53B in FIG. 23 causes the end heat generation portions 60A and 60C adjacent to both sides of the central heat generation portion 60B to generate heat. Applying the voltage between the left electrode 53A and the right electrode 53C causes the central heat generation portion 60B to generate heat. To fix the image onto a small sheet, the central heat generation portion 60B alone can generate heat. To fix the image onto a large sheet, all the heat generation portions 60A to 60C can generate heat. As a result, the heater in the fixing device can generate heat in accordance with the size of the sheet.

As illustrated in FIG. 24, the heater holder 25 includes the recess 25a to receive and hold the heater 23 and the thermal equalization plate 24. The recess 25a is formed on the side of the heater holder 25 facing the heater 23. The recessed portion 25a has a bottom 25f formed in a rectangular shape substantially the same size as the heater 23, and four side walls 25g, 25h, 25i, and 25j disposed on four sides of the bottom 25f, respectively. In FIG. 24, the right side wall 25j is omitted. The recessed 25a may have an opening that opens toward one end in the longitudinal direction of the heater 23. The opening is configured by removing one of a pair of the left side wall 25g and the right side wall 25j that intersect the longitudinal direction X of the heater 23 (that is, the arrangement direction of the resistive heat generators 51).

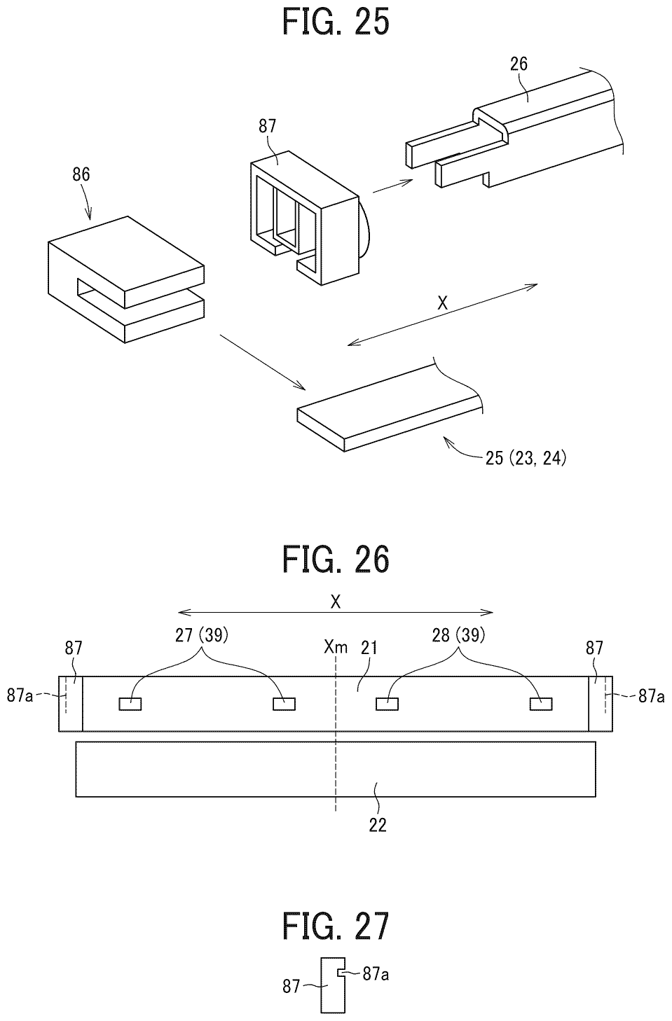

As illustrated in FIG. 25, a connector 86 holds the heater holder 25 that holds the heater 23 and the thermal equalization plate 24. The connector 86 includes a housing made of resin such as LCP and a plurality of contact terminals fixed to the inner surface of the housing.

To attach the connector 86 to the heater holder 25, the connector 86 is moved in the direction intersecting the longitudinal direction X of the heater 23 that is the arrangement direction of the resistive heat generators 51 (see a direction indicated by an arrow extending from the connector 86 in FIG. 25). After the connector 86 is attached to the heater holder 25, the heater 23, the thermal equalization plate 24, and the heater holder 25 are sandwiched and held by the connector 86. In this state, the contact terminals contact and press against the electrodes of the heater 23, respectively, and the resistive heat generators 51 are electrically coupled to the power supply disposed in the image forming apparatus via the connector 86. As a result, the power supply can supply electric power to the resistive heat generators 51.

A flange 87 illustrated in FIG. 25 is the belt holder in contact with the inner circumferential surface of the fixing belt 21 at each of both ends of the fixing belt 21 in the longitudinal direction of the fixing belt 21 to hold the fixing belt 21. The flanges 87 are inserted into both ends of the stay 26 and fixed to a pair of side plates that are frame members of the fixing device, respectively.

FIG. 26 is a diagram illustrating an arrangement of temperature sensors 39.

As illustrated in FIG. 26, temperature sensors 39 include thermistors 27 for temperature control and thermostats 28 for preventing excessive temperature rise. Two thermistors 27 are disposed to face a region from the center Xm of the fixing belt 21 to one end of the fixing belt 21 in the longitudinal direction. On the other hand, two thermostats 28 are disposed a region from the center Xm of the fixing belt 21 to the other end of the fixing belt 21 in the longitudinal direction.

As illustrated in FIGS. 26 and 27, flanges 87 to hold both ends of the fixing belt 21 each have a slide groove 87a. The slide groove 87a extends in a direction in which the fixing belt 21 moves toward and away from the pressure roller 22. An engaging portion of a housing of the fixing device is engaged with the slide groove 87a. The relative movement of the engaging portion in the slide groove 87a enables the fixing belt 21 to move toward and away from the pressure roller 22.

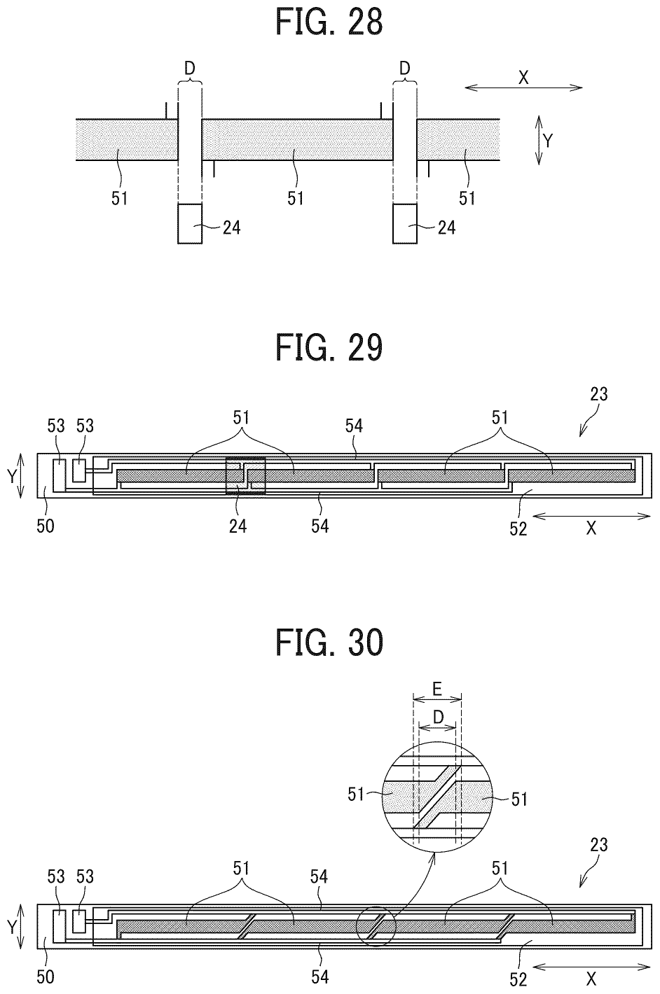

The thermal equalization plate 24 is not limited to be disposed so as to cover the entire heat generation region of the heater 23 in the longitudinal direction X. For example, as illustrated in FIG. 28, the thermal equalization plate 24 may be disposed so as to cover only the separation area B between the resistive heat generators 51. In FIG. 28, for the sake of convenience, the separation areas D and the thermal equalization plates 24 are shifted in the vertical direction of FIG. 28 but are disposed at substantially the same position in the short-side direction Y of the heater 23. The thermal equalization plate 24 may be disposed so as to cover a part of the separation area D in the short-side direction Y of the heater 23 or may be disposed so as to entirely cover the separation area D in the short-side direction Y of the heater 23. As illustrated in FIG. 29, the thermal equalization plates 24 may be disposed so as to cover parts of the resistive heat generators 51 interposing both sides of the separation area D in addition to the separation area D between the resistive heat generators 51. The thermal equalization plate 24 may be disposed so as to cover at least a part of the resistive heat generators 51 interposing both sides of the separation area D. The thermal equalization plate 24 may be disposed so as to cover all the separation areas D of the heater 23 or may be disposed so as to cover some of the separation areas D as illustrated in FIG. 29.

Placing the thermal equalization plate 24 so as to cover the separation area D of the heater 23 enables effectively transferring heat to the separation area D in which a small amount of heat is generated, which reduces a temperature drop in the separation area D. Thus, the thermal equalization plate 24 reduces the temperature unevenness of the heater 23 in the longitudinal direction and the temperature unevenness of the fixing belt 21 in the longitudinal direction. As a result, the above-described structure can prevent uneven fixing and uneven gloss in the image fixed on the sheet. Since the heater 23 does not need to generate additional heat to obtain a sufficient fixing performance in the part of the heater 23 facing the separation area D, energy consumption of the fixing device can be saved. In particular, the thermal equalization plate 24 disposed over the entire heat generation region in which the resistive heat generators 51 are disposed enhances the heat transfer efficiency of the heater 23 over the entire area of a main heating region of the heater 23, that is, an area facing an image formation area of the sheet passing through the fixing device and reduces the temperature unevenness of the heater 23 and the temperature unevenness of the fixing belt 21 in the longitudinal direction.

In addition, the combination of the thermal equalization plate 24 and the resistive heat generator 51 having a Positive Temperature Coefficient (PTC) characteristic effectively prevents the overheating of the non-sheet passing region that is not in contact with the sheet. The PTC characteristic is a characteristic in which the resistance value increases as the temperature increases (a heater output decreases under a constant voltage). The resistive heat generator 51 having the PTC characteristic effectively reduces the amount of heat generated by the resistive heat generator 51 in the non-sheet passing region, and the thermal equalization plate 24 effectively transfers heat from the non-sheet passing region in which the temperature rises to a sheet passing region that is a region of the fixing belt contacting the sheet. As a result, the overheating of the non-sheet passing region is effectively prevented.

Since the temperature of the heater 23 tends to be low not only in the separation area D but also in the periphery of the separation area D, the thermal equalization plate 24 may be disposed so as to cover an enlarged separation area E including the separation area D and the periphery of the separation area D as illustrated in FIG. 30. The thermal equalization plate 24 covering the enlarges separation area can increase the heat transfer efficiency in the enlarged separation area E including the separation area D and more effectively reduce the temperature unevenness in the longitudinal direction X of the heater 23.

The fixing device according to the embodiments of the present disclosure may have the following structure.

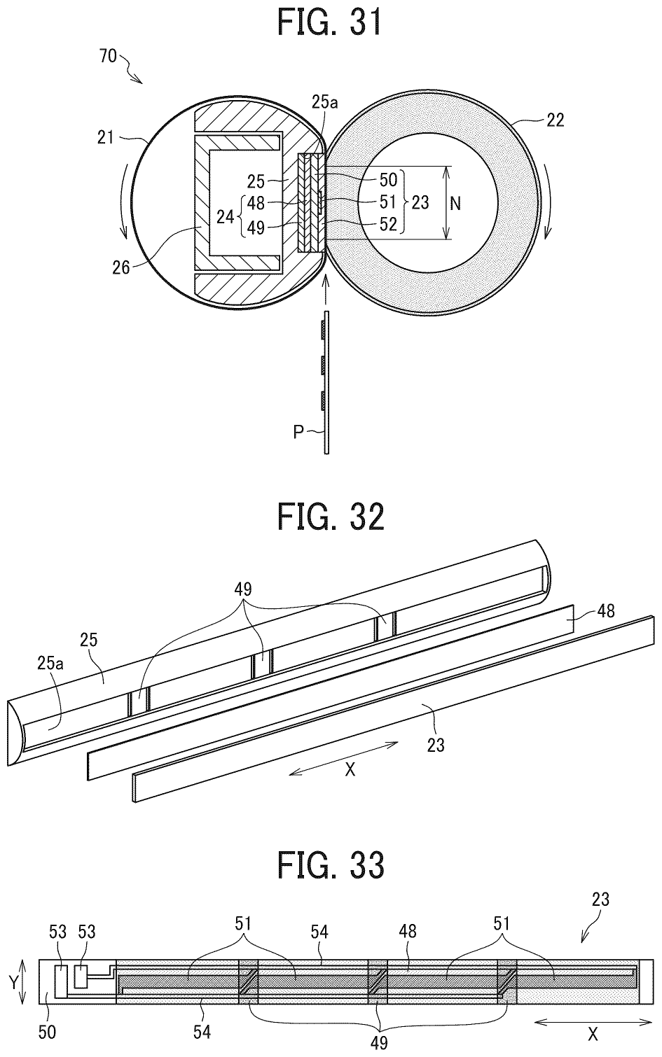

A fixing device 70 illustrated in FIG. 31 includes a first thermal equalization plate 48 and a second thermal equalization plate 49 as the thermal equalization plate 24. The first thermal equalization plate 48 and the second thermal equalization plate 49 form two layers. The first thermal equalization plate 48 is in contact with the heater 23. The second thermal equalization plate 49 is in contact with the first thermal equalization plate 48. The fixing device 70 illustrated in FIG. 31 includes the thermostats and the thermistors contacting the heater 23. FIG. 31 is a cross-sectional view in a cross section in which the thermistor and the thermistor holder are not disposed.

The second thermal equalization plate 49 is made of a material having thermal conductivity higher than the thermal conductivity of the base 50 of the heater 23, for example, graphene or graphite. For example, the second thermal equalization plate 49 is made of a graphite sheet having a thickness of 1 mm. Alternatively, the second thermal equalization plate 49 may be a plate made of aluminum, copper, or silver.

As illustrated in FIG. 32, multiple second thermal equalization plates 49 are arranged at an interval in the longitudinal direction X of the heater 23 on a recess 25a of the heater holder 25. The second thermal equalization plate 49 is placed on a part of the recess 25a of the heater holder 25, and the part of the recess 25a is deeper than the other parts of the recess 25a.

As illustrated in FIG. 33, the second thermal equalization plate 49 (see a hatched portion) is disposed so as to overlap at least a part of each of resistive heat generators 51 interposing the separation area D in the longitudinal direction of the heater 23. On the other hand, the first thermal equalization plate 48 is disposed so as to cover the entire heat generation region including all the resistive heat generators 51. The range in which the first thermal equalization plate 48 or the second thermal equalization plate 49 is disposed is not limited to the above.

The second thermal equalization plate 49 disposed so as to overlap at least a part of each of the resistive heat generators 51 interposing the separation area D further enhances the heat transfer efficiency in the separation area D and more effectively reduces the temperature unevenness in the longitudinal direction X of the heater 23. Alternatively, as illustrated in FIG. 34, the first thermal equalization plate 48 and the second thermal equalization plate 49 may be disposed so as to cover only the entire separation area D. In this case, the heat transfer efficiency in the separation area D can be enhanced. In FIG. 34, for the sake of convenience, the separation areas D, the first thermal equalization plates 48, and the second thermal equalization plates 49 are shifted in the vertical direction of FIG. 34 but are disposed at substantially the same position in the short-side direction Y of the heater 23. However, the arrangement of the first thermal equalization plates 48 and the second thermal equalization plates 49 is not limited to this. The first thermal equalization plate 48 and the second thermal equalization plate 49 may be disposed so as to cover a part of the separation area D in the short-side direction Y of the heater 23 or may be disposed so as to entirely cover the separation area D in the short-side direction Y of the heater 23.

Each of the first thermal equalization plate 48 and the second thermal equalization plate 49 may be made of a graphene sheet. In this case, each of the first thermal equalization plate 48 and the second thermal equalization plate 49 has a high thermal conductivity in a predetermined direction along the plane of graphene, that is, in the longitudinal direction, not in the thickness direction. Accordingly, the above-described structure can effectively reduce the temperature unevenness of the fixing belt 21 in the longitudinal direction and the temperature unevenness of the heater 23 in the longitudinal direction.

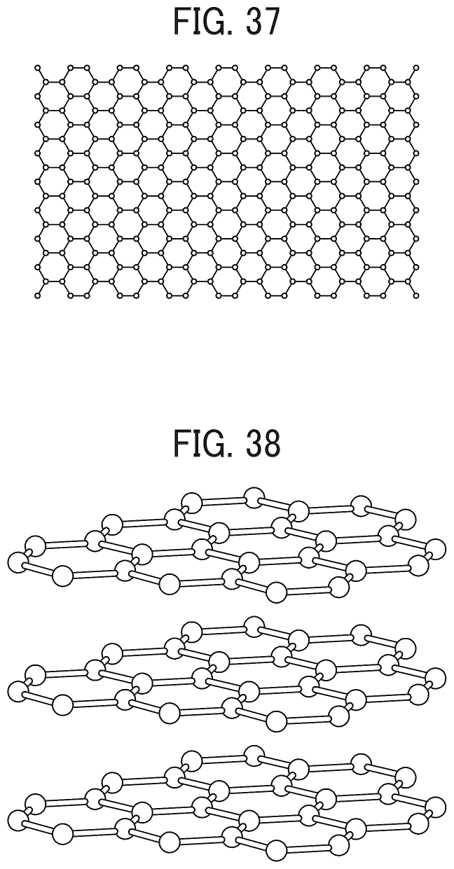

Graphene is a flaky powder. Graphene has a planar hexagonal lattice structure of carbon atoms, as illustrated in FIG. 37. The graphene sheet is typically a single layer. The graphene sheet may contain impurities in a single layer of carbon or may have a fullerene structure. The fullerene structures are generally recognized as compounds including an even number of carbon atoms, which form a cage-like fused ring polycyclic system with five and six membered rings, including, for example, C60, C70, and C80 fullerenes or other closed cage structures having three-coordinate carbon atoms.

Graphene sheets are artificially made by, for example, a chemical vapor deposition (CVD) method.

The graphene sheet is commercially available. The size and thickness of the graphene sheet or the number of layers of the graphite sheet described below are measured by, for example, a transmission electron microscope (TEM).

Graphite obtained by multilayering graphene has a large thermal conduction anisotropy. As illustrated in FIG. 38, the graphite has a crystal structure formed by layering a number of layers each having a condensed six membered ring layer plane of carbon atoms extending in a planar shape. Among carbon atoms in this crystal structure, adjacent carbon atoms in the layer are coupled by a covalent bond, and carbon atoms between layers are coupled by a van der Waals bond. The covalent bond has a larger bonding force than a van der Waals bond. Therefore, there is a large anisotropy between the bond between carbon atoms in a layer and the bond between carbon atoms in different layers. As a result, the thermal equalization plates 24 including the first thermal equalization plate 48 and the second thermal equalization plate 49 that are made of graphite has the heat transfer efficiency in the longitudinal direction greater than the heat transfer efficiency in the thickness direction of the thermal equalization plate 24 (that is, the stacking direction of these members), reducing the heat transferred to the heater holder 25. Accordingly, the above-described structure can efficiently decrease the temperature unevenness of the heater 23 in the longitudinal direction X and can minimize the heat transferred to the heater holder 25. Since the thermal equalization plate 24 made of graphite is not oxidized at about 700 degrees or lower, the thermal equalization plate 24 has an excellent heat resistance.

The physical properties and dimensions of the graphite sheet may be appropriately changed according to the function required for the thermal equalization plate 24. For example, the anisotropy of the thermal conduction can be increased by using high-purity graphite or single-crystal graphite or increasing the thickness of the graphite sheet. Using a thin graphite sheet can reduce the thermal capacity of the fixing device so that the fixing device can perform high-speed printing. A width of the thermal equalization plate 24 in the short-side direction of the thermal equalization plate 24 may be increased in response to a large width of the fixing nip N or a large width of the heater 23.

From the viewpoint of increasing mechanical strength, the number of layers of the graphite sheet is preferably 11 or more. The graphite sheet may partially include a single layer portion and a multilayer portion.

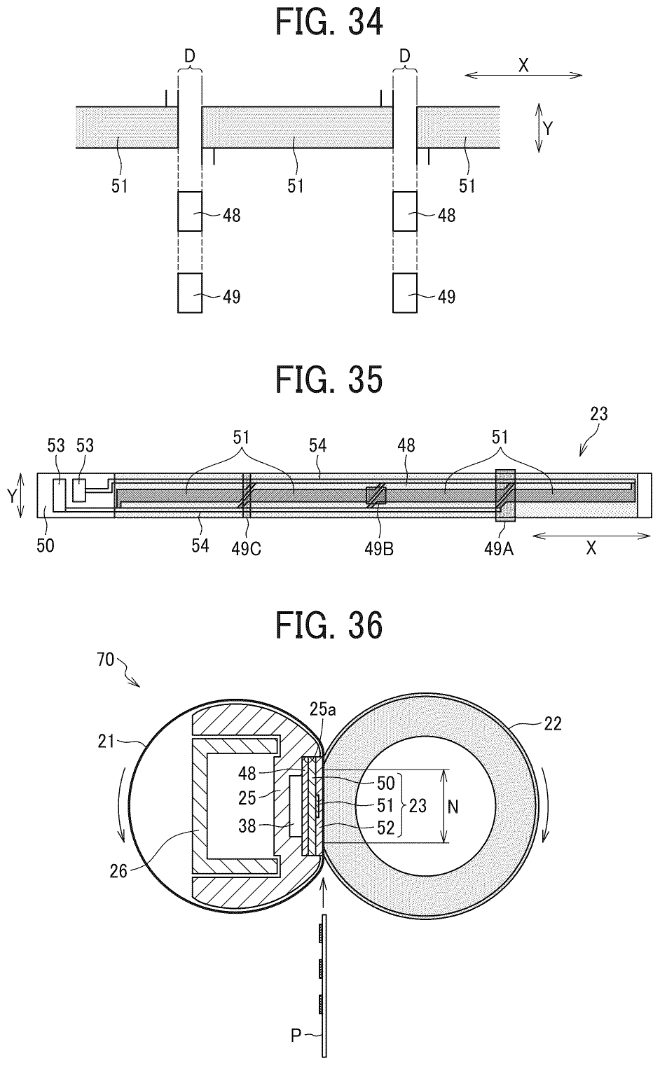

As long as the second thermal equalization plate 49 faces at least a part of the separation area D and each of resistive heat generators 51 at both sides of the separation area D in the longitudinal direction of the heater 23, the configuration of the second thermal equalization plate 49 is not limited to the configuration illustrated in FIG. 34. For example, as illustrated in FIG. 35, a second thermal equalization plate 49A projects from both sides of the base 50 of the heater 23 in the short-side direction Y of the heater 23. A second thermal equalization plate 49B faces a range in which the resistive heat generator 51 is disposed in the short-side direction Y of the heater 23. A second thermal equalization plate 49C is disposed to face a part of the separation area D.

As illustrated in FIG. 36, the fixing device may have a gap 38 between the first thermal equalization plate 48 and the heater holder 25 in the thickness direction that is the lateral direction in FIG. 36. In other words, the fixing device has the gap 38 serving as a thermal insulation layer in a part of a region of the recess 25a (see FIG. 32) of the heater holder 25 in which the heater 23, the first thermal equalization plate 48, and the second thermal equalization plates 49 are disposed. The gap 38 is in the part of the region of the recess 25a, and the second thermal equalization plate 49 is not in the part. For this reason, FIG. 36 does not include the second thermal equalization plate 49.

The gap 38 has a depth deeper than the depth of the recess 25a of the heater holder 25. Since the gap 38 reduces the area of contact between the heater holder 25 and the first thermal equalization plate 48, the gap 38 reduce heat transfer from the first thermal equalization plate 48 to the heater holder 25 and enables the heater 23 to efficiently heat the fixing belt 21. As illustrated in FIG. 31, the second thermal equalization plate 49 is held in contact with the bottom of the recess 25a of the heater holder 25.

The gap 38 is in an entire area in which the resistive heat generators 51 are disposed in the short-side direction Y of the heater 23 that is the vertical direction in FIG. 36. Such a configuration effectively reduces the heat transfer from the first thermal equalization plate 48 to the heater holder 25 and enhances the efficiency of heating the fixing belt 21 by the heater 23. The fixing device may include a thermal insulation layer made of heat insulator having a lower thermal conductivity than the thermal conductivity of the heater holder 25 in the gap 38.

The first thermal equalization plate 48 and the second thermal equalization plates 49 need not be separated from each other and may be integrated with each other. The first thermal equalization plate 48 may have a thicker portion than the other portion so that the thicker portion faces the separation area D and functions as the second thermal equalization plate 49.

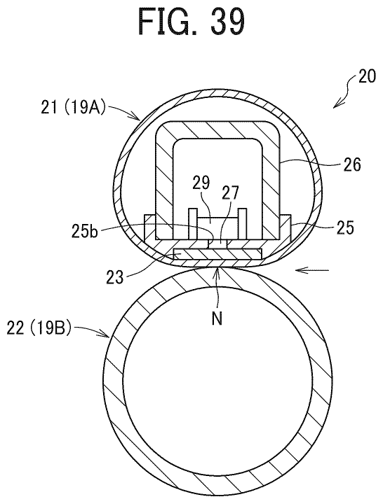

The fixing device 20 illustrated in FIG. 39 does not include the thermal equalization plate, and the thermistor 27 directly contacts the heater 23 via the through hole 25b of the heater holder 25. The heater 23 is a planar heater including resistive heat generators on the base. The heater holder 25 is made of a heat-resistant resin.

In the above, various configurations of the fixing device and the image forming apparatus in which the embodiments of the present disclosure can be applied are described. Applying the embodiments to the various configurations of the fixing device and the image forming apparatus gives effects similar to the above-described effects in the embodiments. Applying the embodiments of the present disclosure can reduce the inclination of the thermistor holder 29 and maintain the detection accuracy of the thermistor 27 at high accuracy.

The fixing device is one example of the heating device. The present embodiments are not limited to applying the fixing device and may be applied to the heating device other than the fixing device. The present embodiments can be applied to, for example, a heating device such as a dryer to dry liquid such as ink applied to the sheet, a laminator that heats, under pressure, a film serving as a covering member onto the surface of the sheet such as paper, and a thermocompression device such as a heat sealer that seals a seal portion of a packaging material with heat and pressure. Applying the present disclosure to the heating device can reduce the inclination of the first holder.

Aspects of the present disclosure are, for example, as follows.

### <First Aspect>

In a first aspect, a heating device includes a rotator, a contact-type temperature sensor including a temperature detector, a first holder to hold the temperature sensor, a second holder to hold the first holder, and an electric wire extending in a first direction. The temperature sensor is biased toward a detected member. A direction intersecting the first direction and the direction in which the temperature sensor is biased and a direction opposite thereto is defined as a second direction. A direction intersecting the second direction and the direction orthogonal to the first direction is defined as a third direction. The first holder includes a supporting portion extending in the second direction, a supported portion extending in the third direction, and a contacting portion contacting the second holder in the third direction. The supporting portion supports one end of the supported portion in the third direction. The first holder has a wiring space extending from the supported portion to the supporting portion in the second direction and opening toward the other end of the supported portion in the third direction to wire the electric wire in the first direction. The supporting portion has one end contacting the supported portion and the other end contacting a face of the first holder in the second direction. The face of the first holder is defined as a reference face. A distance in the second direction from the reference face toward the supported portion is defined as a height. A contact height in which the contact portion contacts the second holder is higher than a height of the wiring space.

### <Second Aspect>

In a second aspect, a heating device includes a rotator, a heater including a base and a heat generator, a contact-type temperature sensor including a temperature detector, a first holder to hold the temperature sensor, a second holder to hold the first holder, and an electric wire extending in a first direction. The temperature sensor is biased toward a detected member. A direction intersecting the first direction and the direction in which the temperature sensor is biased and a direction opposite thereto is defined as a second direction. A direction intersecting the second direction and the direction orthogonal to the first direction is defined as a third direction. The first holder includes a supporting portion extending in the second direction, a supported portion extending in the third direction, and a contacting portion contacting the second holder in the third direction. The supporting portion supports one end of the supported portion in the third direction. The first holder has a wiring space extending from the supported portion to the supporting portion in the second direction and opening toward the other end of the supported portion in the third direction to wire the electric wire in the first direction. The rotator faces a face of the heater, and the face of the heater is defined as a reference face. A distance in the second direction from the reference face toward the supported portion is defined as a height. A contact height in which the contact portion contacts the second holder is higher than a height of the wiring space.

### <Third Aspect>

In a third aspect, a heating device includes a rotator, a contact-type temperature sensor including a temperature detector, a first holder to hold the temperature sensor, a second holder to hold the first holder, and an electric wire extending in a first direction. The temperature sensor is biased toward a detected member. A direction intersecting the first direction and the direction in which the temperature sensor is biased and a direction opposite thereto is defined as a second direction. A direction intersecting the second direction and the direction orthogonal to the first direction is defined as a third direction. The first holder includes a supporting portion extending in the second direction, a supported portion extending in the third direction, and a contacting portion contacting the second holder in the third direction. The supporting portion supports one end of the supported portion in the third direction. The first holder has a wiring space extending from the supported portion to the supporting portion in the second direction and opening toward the other end of the supported portion in the third direction to wire the electric wire in the first direction. A direction from the supporting portion to the supported portion in the second direction is defined as a height in the second direction. A contact height in which the contact portion contacts the second holder is higher than a face of the contacted support, the face facing the wiring space.

### <Fourth Aspect>

In a fourth aspect, the contacting portion of the first holder in the heating device according to any one of the first to third aspects includes a first contacting portion and a second contacting portion, and the second holder has one side and the other side in the third direction. The first contacting portion contacts the one side of the second holder, and the second contacting portion contacts the other side of the second holder.

### <Fifth Aspect>

In a fifth aspect, the second holder in the heating device according to the fourth aspect includes a first contacted portion contacted by the first contacting portion and a second contacted portion contacted by the second contacting portion, the first contacted portion and the second contacted portion is spaced apart in the third direction, the first holder includes a fitting portion having the first contacting portion and the second contacting portion on both sides in the third direction, and fitting the fitting portion to a space between the first contacted portion and the second contacted portion positions the first holder with respect to the second holder.

### <Sixth Aspect>

In a sixth aspect, the heating device according to any one of the first to fifth aspects further includes one or more other first holders disposed to be away from one end or the other end of the first holder in the first direction, the one or more other first holders each include another supporting portion and another supported portion and each have another wiring space opening toward one end or the other end of said another supported portion in the third direction. The first holder having the wiring space opening toward the other end and the one or more other first holders having the wiring spaces opening toward one end and the other end are arranged such that the wiring space opening toward one end and the wiring space opening toward the other end are alternately arranged in the first direction.

### <Seventh Aspect>

In a seventh aspect, the first holder in the heating device according to any one of the first to sixth aspects includes another contacting portion at one end of the first holder in the first direction, and the contacting portion is at the other end of the first holder in the first direction.

### <Eighth Aspect>

In an eighth aspect, the heating device according to any one of the first to seventh aspects includes the first holder holding the temperature sensor and the second holder holding the first holder, and the first holder, the second holder, and the temperature sensor have positioning portions. A dimensional difference between the positioning portion of the first holder and the positioning portion of the second holder in the third direction is smaller than a dimensional difference between the positioning portion of the first holder and the positioning portion of the temperature sensor in the third direction.

### <Ninth Aspect>

In a ninth aspect, a fixing device uses the heating device according to any one of the first to eighth aspects to fix an image on a recording medium onto the recording medium.

### <Tenth Aspect>

In a tenth aspect, an image forming apparatus includes the fixing device according to the ninth aspect.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A heating device comprising:
an electric wire extending in a first direction;
a temperature sensor in contact with a target to detect a temperature of the target;
an elastic body to press the temperature sensor toward the target in a second direction intersecting the first direction;
a first holder to hold the temperature sensor, the first holder including:
a supported portion extending from one end to another end in a third direction orthogonal to the first direction and intersecting the second direction;
a supporting portion extending from one end to another end in the second direction, the one end of the supporting portion being connected to the one end of the supported portion, the supported portion being cantilevered from the supporting portion in the third direction to form a wiring space to keep the electric wire extending in the first direction;
a reference face contacting said another end of the supporting portion; and
a contacting portion raised from the reference face in the second direction; and
a second holder to hold the first holder,
the second holder in contact with the contacting portion of the first holder for a contact height in the second direction, the contact height larger than a height of the wiring space in the second direction.

2. A heating device comprising:
a rotator;
a heater including:
a base;
a heat generator on the base; and
a reference face facing the rotator;
an electric wire extending in a first direction;
a temperature sensor in contact with a target to detect a temperature of the target;
an elastic body to press the temperature sensor toward the target in a second direction intersecting the first direction;
a first holder to hold the temperature sensor, the first holder including:
a supported portion extending from one end to another end in a third direction orthogonal to the first direction and intersecting the second direction;
a supporting portion extending from one end to another end in the second direction, the one end of the supporting portion being connected to the one end of the supported portion, the supported portion being cantilevered from the supporting portion in the third direction to form a wiring space to keep the electric wire extending in the first direction; and
a contacting portion extending in the second direction; and
a second holder to hold the first holder,
the second holder in contact with the contacting portion of the first holder,
wherein a distance from the reference face to a position farthest from the reference face among positions at which the contacting portion contacts the second holder is larger than a distance from the reference face to a face of the supported portion facing the reference face in the second direction.

3. A heating device comprising:
an electric wire extending in a first direction;
a temperature sensor in contact with a target to detect a temperature of a target;
an elastic body to press the temperature sensor toward the target in a second direction intersecting the first direction;
a first holder to hold the temperature sensor, the first holder including:
a supported portion extending from one end to another end in a third direction orthogonal to the first direction and intersecting the second direction;
a supporting portion extending from one end to another end in the second direction, the one end of the supporting portion being connected to the one end of the supported portion, the supported portion being cantilevered from the supporting portion in the third direction to form a wiring space to keep the electric wire extending in the first direction;
a reference face contacting said another end of the supporting portion; and
a contacting portion raised from the reference face in the second direction; and
a second holder to hold the first holder,
the second holder contacting the contacting portion of the first holder,
wherein a position farthest from the reference face among positions at which the contacting portion contacts the second holder is farther from the reference face than a face of the supported portion facing the reference face in the second direction.

4. The heating device according to claim 1,
wherein the contacting portion of the first holder includes:
a first contacting portion at one end of the first holder in the third direction, the first contacting portion contacting the second holder; and
a second contacting portion at another end of the first holder in the third direction, the second contacting portion contacting the second holder.

5. The heating device according to claim 4,
wherein the second holder includes:
a first contacted portion contactable with the first contacting portion; and
a second contacted portion contactable with the second contacting portion and separated from the first contacted portion by a gap in the third direction,
the first holder includes a fitting portion fitted in a space between the first contacted portion and the second contacted portion to position the first holder to the second holder, and
the first contacting portion and the second contacting portion are at both ends of the fitting portion in the third direction.

6. The heating device according to claim 1, further comprising
another first holder disposed to be away from the first holder in the first direction, said another first holder including:
another supported portion extending from one end to another end in the third direction; and
another supporting portion extending from one end to another end in the second direction, the one end of said another supporting portion being connected to said another end of said another supported portion, said another supported portion being cantilevered from said another supporting portion in the third direction to form another wiring space to keep the electric wire extending in the first direction,
wherein an opening direction of the wiring space is opposite to an opening direction of said another wiring space.

7. The heating device according to claim 1,
wherein the contacting portion of the first holder includes:
a third contacting portion at one end of the first holder in the first direction; and
a fourth contacting portion at another end of the first holder in the first direction.

8. The heating device according to claim 1,
wherein a positioning play between the first holder and the second holder in the third direction is smaller than a positioning play between the first holder and the temperature sensor in the third direction.

9. A fixing device comprising
the heating device according to claim 1.

10. A fixing device comprising
the heating device according to claim 2.

11. A fixing device comprising
the heating device according to claim 3.

12. An image forming apparatus comprising
the fixing device according to claim 9.

13. An image forming apparatus comprising
the fixing device according to claim 10.

14. An image forming apparatus comprising
the fixing device according to claim 11.
